(19) United States
(12) Patent Application Publication
(10) Pub. No.: US 2008/0248162 A1
(43) Pub. Date: Oct. 9, 2008

(54) On-demand meat tenderizing package

(75) Inventors: Leslie E. Cook, Simpsonville, SC (US); Allen C. Williams, Moore, SC (US); Blaine C. Childress, Inman, SC (US); Joseph E. Owensby, Spartanburg, SC (US); Henry Walker Stockley, Spartanburg, SC (US); William G. Kuecker, Dixon Springs, TN (US)

Correspondence Address: Sealed Air Corporation, P.O. Box 464, Duncan, SC, 29334, US

(73) Assignee: Cryovac, Inc.

(21) Appl. No.: 12/079,409

(22) Filed: Mar. 26, 2008

Related U.S. Application Data
(60) Provisional application No. 60/920,248, filed on Mar. 27, 2007.

(51) Int. Cl. B65D 25/08; A23L 1/318; A23L 1/00; B65D 81/32

(52) U.S. Cl. 426/61; 426/112; 426/394

(57) ABSTRACT

The presently disclosed subject matter is directed to a compartmented marinade package comprising a food product, such as a cut of meat, loaded into a first compartment and a frozen food additive loaded into a second compartment. The package includes a rupturable seal separating the two compartments to allow the mixing and marinating of the food product and food additive when desired by a user. The user squeezes the desired storage chamber and the pressure applied thereto causes the rupturable seal to break, allowing intermixing between the compartments.

### CROSS-REFERENCE TO RELATED APPLICATIONS

The subject application claims the benefit under 35 U.S.C. §119(e) of U.S. Provisional Patent Application No. 60/920,248, filed Mar. 27, 2007, the contents of which are incorporated herein by reference thereto.

### BACKGROUND

Of the several sensory characteristics of meat, tenderness is perhaps the trait most highly desired by consumers. Consequently, meat tenderness is a factor of major economic importance to the livestock and meat industries. Accordingly, the consumer acceptance of meat, e.g., beef, pork and poultry, depends to a large measure on the tenderness of the meat after cooking. When the meat is tough and fibrous, consumer acceptance is quite low. Meat prepared for home consumption and sold in local groceries and butcheries is normally of the more tender grades. For example, in the case of beef, lot feeding can be required to develop the desired amount of tenderness in the muscle tissue, including increases in fat content. However, such efforts can considerably increase the cost of the meat. For this reason, significant effort has been expended in the art to provide methods for tenderizing less tender grades of meat.

Commonly, food additives (such as, for example, marinades) can be used to enhance the qualities of meats by providing enhanced visual appearance and tenderness from spices and flavorings. For example, some techniques utilize injection of flavorings into the muscle to impart flavor and juiciness prior to packaging the meat. Other techniques include a means of tumbling a meat product in a marinade prior to packaging. In the case of the injected or tumbled marinade techniques, the use of a tenderizer is often omitted because the proteolytic enzyme associated with tenderizing agents can overly soften the meat, resulting in an unsatisfactory texture. The over-tenderizing results from prolonged contact time between the meat and the tenderizing agent as a consequence of the poor ability to control the exposure time during distribution. Additionally, even without considering the role of a proteolytic enzyme, the quality of a pre-marinated package is necessarily inconsistent as the meat generally is exposed for too long to the flavorants.

Alternatively, restaurants or consumers can purchase a vacuum packaged meat package, cut open the package, and transfer the meat to a second bag wherein a marinade is added, or to a tray or vat that is loaded with a marinade. With the tray, vat, or second bag method, a consumer removes the meat from its shipment package and necessarily exposes the meat to outside conditions that can introduce contamination during marinating. In addition, the method can introduce the undesirable step of cleaning the tray or vat to prevent cross-contamination.

### SUMMARY

With the foregoing in mind, it is an object of the presently disclosed subject matter to provide flexible packages having a unique rupturable seal that maintains two or more components separately while being readily rupturable upon desired mixing of the separated components.

Particularly, the presently disclosed subject matter describes a hermetically sealed compartmented package comprising a first thermoplastic flexible film and a second thermoplastic film. In some embodiments, the first flexible film has been thermoformed into at least two compartments. The first compartment can receive a volume of fresh or frozen additive (such as a flavored marinade and/or proteolytic enzyme). The second compartment can receive a food item, such as a meat product.

The second thermoplastic flexible film can be peelably heat sealed to the first film, after optionally removing the ambient air from the compartments, to form a package having an outside perimeter seal and a pressure rupturable interior seal. The rupturable seal can hermetically separate the two compartments. When desired, pressure (such as, for example, mechanical or hand pressure) can be applied to the first or second compartment to hydraulically break the rupturable seal, thereby allowing fluid communication between the first and second compartments, and permitting the onset of flavoring or tenderizing of a meat product. In such an arrangement, the second thermoplastic film or laminate serves as the “lid” and the first thermoformable thermoplastic film serves a “support member”. In some embodiments, the lid forms hermetic seals with the support member, and remains hermetic before and during marinating to preserve the meat during distribution.

In some embodiments, the compartments housing the marinade and/or meat product can contain a secondary heat seal. The secondary seal can provide an added safety measure, ensuring that leakage of one or both compartments does not occur as a result of the increased pressure exerted by the user while breaking the rupturable seal.

In some embodiments, the presently disclosed subject matter is directed to a package for marinating a food item. The package can comprise a first thermoformed film formed into a compartmented support member having at least two compartments, wherein a first compartment is adapted to contain a fresh or frozen food additive and a second compartment is adapted to contain a food product. A second film can be peripherally sealed about the perimeter of the package to the first film forming a hermetically sealed container having a perimeter seal. A rupturable seal can be positioned between the at least two compartments, wherein the seal is rupturable due to manual squeezing of one of the compartments to allow the food additive to mix with the food product. The rupturable seal has a lower rupture pressure compared to the perimeter seal. The food item can be marinated directly in the package.

In some embodiments, the presently disclosed subject matter is directed to a method of controlling the level of food additive imparted to a food product. The method can comprise forming a first thermoformable thermoplastic film into a compartmented support member having at least two compartments, wherein a first compartment is adapted to contain a food additive and a second compartment is adapted to contain a food product. The compartmented support member can be loaded with a charge of fresh or frozen food additive into a first compartment and a charge of a food product into a second compartment. A vacuum can then be applied to the first and second charged compartments, and the second film peripherally sealed about the perimeter of the compartmented support member to form a perimeter seal. A rupturable seal can be positioned between the at least two compartments, the seal being rupturable due to manual squeezing of at least one compartment to allow the food additive to mix with the food product. The rupturable seal can have a lower rupture pressure compared to the perimeter seal, and the food item can be marinated directly in the package.

In some embodiments, the presently disclosed subject matter is directed to a process of marinating a food product in package. A first thermoformable thermoplastic film can be formed into a compartmented support member having at least two compartments, wherein a first compartment is adapted to contain a food additive and a second compartment is adapted to contain a food product. The compartmented support member can be loaded with a charge of fresh or frozen food additive into the first compartment and a charge of a food product into the second compartment. A vacuum can be applied to the first and second charged compartments. The second film can be peripherally sealed about the perimeter of the compartmented support member. A rupturable seal can be positioned between the at least two compartments, the seal being rupturable due to manual squeezing of at least one compartment to allow the food additive to mix with the food product. The package is such that the rupturable seal has a lower rupture pressure compared to the perimeter seal, and the food item can be marinated directly in the package.

It is therefore an object of the presently disclosed subject matter to provide a self-contained marinade package.

An object of the presently disclosed subject matter having been stated hereinabove, other objects and advantages will become apparent to those of ordinary skill in the art after a study of the following description and non-limiting examples. Like numerals refer to like elements throughout.

### BRIEF DESCRIPTION OF THE DRAWINGS

FIGS. 1-2 are perspective views of compartmented packages according to some embodiments of the presently disclosed subject matter.

FIG. 3 is a schematic view of one process for making a multilayer film in accordance with the presently disclosed subject matter.

### DETAILED DESCRIPTION

### I. General Considerations

The presently disclosed subject matter comprises a compartmented package that has at least two separate compartments, yet can permit the intermixing of the items housed within the compartments upon the rupture of a rupturable seal that separates the compartments. The first and second compartments are located adjacent to each other separated by at least one common side comprising a rupturable seal. Although the rupturable seal is sealed between the compartments, it can be fractured to permit the free flow of materials between the compartments. Thus, after rupture, the items housed in the two compartments can be readily intermixed in the same package without exposure to the outside environment. After a desired amount of marinating time, the marinated food product can be removed from the package and placed in an oven or microwave and cooked or heated.

The disclosed system allows the freshness of the food product to be maintained by the physical separation between the components. In addition, an ideal marinade time can be accomplished by the user, preventing over-tenderizing of the food product. Further, the presently disclosed marinating package limits the amount of contamination compared to prior art packages by providing a hermetically sealed container that is not exposed to the outside environment prior to marinating.

### II. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a package” (e.g., “a marinade package”) includes a plurality of such packages, and so forth.

Unless otherwise indicated, all numbers expressing quantities of components, reaction conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, percentage, and the like can encompass variations of, in some embodiments ±20%, in some embodiments ±10%, in some embodiments ±5%, in some embodiments ±1%, in some embodiments ±0.5%, and in some embodiments ±0.1%, from the specified amount, as such variations are appropriate in the disclosed package and methods.

As used herein, the phrase “abuse layer” refers to an outer film layer and/or an inner film layer, so long as the film layer serves to resist abrasion, puncture, and other potential causes of reduction of package integrity, as well as potential causes of reduction of package appearance quality. Abuse layers can comprise any polymer, so long as the polymer contributes to achieving an integrity goal and/or an appearance goal. In some embodiments, an abuse layer can comprise polymers having a modulus of at least 10⁷ Pascals, at room temperature. In some embodiments, an abuse layer can comprise, but is not limited to, polyamide and/or ethylene/propylene copolymer; in some embodiments, nylon 6, nylon 6/6, and/or amorphous nylon.

As used herein, the term “barrier”, and the phrase “barrier layer”, as applied to films and/or layers, can be used with reference to the ability of a film or layer to serve as a barrier to one or more gases. In the packaging art, oxygen (i.e., gaseous O₂) barrier layers have included, for example, ethylene/vinyl alcohol copolymer (polymerized ethylene vinyl alcohol), polyvinyl chloride, polyvinylidene chloride (PVDC), polyalkylene carbonate, polyamide, polyethylene naphthalate, polyester, polyacrylonitrile, and the like, as known to those of ordinary skill in the art. In some embodiments, the O₂-barrier layer can comprise ethylene/vinyl alcohol copolymer, polyvinyl chloride, polyvinylidene chloride, and/or polyamide.

As used herein, the terms “corona treatment” and “corona discharge treatment” refer to subjecting the surfaces of thermoplastic materials, such as polyolefins, to corona discharge, i.e., the ionization of a gas such as air in close proximity to a film surface, the ionization initiated by a high voltage passed through a nearby electrode, and causing oxidation and other changes to the film surface, such as surface roughness. Corona treatment of polymeric materials is disclosed in U.S. Pat. No. 4,120,716, to Bonet, herein incorporated in its entirety by reference thereto. U.S. Pat. No. 4,879,430, to Hoffman, also hereby incorporated in its entirety by reference thereto, discloses the use of corona discharge for the treatment of plastic webs for use in meat cook-in packaging, with the corona treatment of the inside surface of the web to increase the adhesion of the meat to the proteinaceous material.

As used herein, the term “film” can be used in a generic sense to include plastic web, regardless of whether it is film or sheet.

As used herein, the term “food additive” refers to any liquid or solid material that results or can reasonably be expected to result, directly or indirectly, in its becoming a component or otherwise affecting the characteristics of any food product. In some embodiments, the food additive can, for example, be an agent having a distinct taste and/or flavor, such as a salt or any other taste or flavor potentiator or modifier. Examples of food additives include, but are not limited to, marinades and proteolytic enzymes. In addition, components that by themselves are not additives, such as vitamins, minerals, color additives, herbal additives (e.g., echinacea or St. John's Wort), antimicrobials, preservatives, and the like can be considered food additives.

As used herein, the term “food product” refers to any nourishing substance that is eaten or otherwise taken into the body to sustain life, provide energy, promote growth, and/or the like. For example, in some embodiments, food products can include, but are not limited to, meats, vegetables, fruits, starches, and combinations thereof. In some embodiments, food products can include individual food components or mixtures thereof.

As used herein, the term “heat seal” refers to any seal of a first region of a film surface to a second region of a film surface, wherein the seal is formed by heating the regions to at least their respective seal initiation temperatures. Heat-sealing is the process of joining two or more thermoplastic films or sheets by heating areas in contact with each other to the temperature at which fusion occurs, usually aided by pressure. In some embodiments, heat-sealing can be inclusive of thermal sealing, melt-bead sealing, impulse sealing, dielectric sealing, and/or ultrasonic sealing. The heating can be performed by any one or more of a wide variety of means, such as (but not limited to) a heated bar, hot wire, hot air, infrared radiation, ultrasonic sealing, and the like.

As used herein, the term “lamination”, the term “laminate”, and the phrase “laminated film”, can refer to the process and resulting product made by bonding together two or more layers of film and/or other materials. Lamination can be accomplished by joining film layers with adhesives, joining with heat and pressure, spread coating, and/or extrusion coating. In some embodiments, the term “laminate” can be inclusive of coextruded multilayer films comprising one or more tie layers.

As used herein, the term “marinade” refers to an edible substance that can impart one or more flavors and/or textures to a food item. In some embodiments, the marinade can comprise acidic ingredients, such as vinegar, lemon juice, and/or wine. In some embodiments, the marinade can comprise savory ingredients, such as soy sauce, brine, or other prepared sauces. In some embodiments, the marinade can comprise oils, herbs, and spices to further flavor a food item. In some embodiments, the marinade can comprise one or more proteolytic enzymes to flavor the food and/or to tenderize a food item.

As used herein, the term “meat” comprises both cooked and uncooked meat and includes, but is not limited to, beef, birds such as poultry (including chicken, duck, goose, turkey, and the like), buffalo, camel, crustacean (including shellfish, clams, scallops, mussels, oysters, lobster, crayfish, crab, shrimp, prawns, and the like), dog, fish (including salmon, trout, eel, cod, herring, plaice, whiting, halibut, turbot, ling, squid, tuna, sardines, swordfish, dogfish, shark, and the like), game (including deer, eland, antelope, and the like), game birds (such as pigeon, quail, doves, and the like), goat, hare, horse, kangaroo, lamb, marine mammals (including whales and the like), amphibians (including frogs and the like), monkey, pig, rabbit, reptiles (including turtles, snakes, alligators, and the like), and/or sheep.

As used herein, the term “oriented” refers to a polymer-containing material that has been stretched at an elevated temperature (the orientation temperature), followed by being “set” in the stretched configuration by cooling the material while substantially retaining the stretched dimensions. Upon subsequently heating unrestrained, unannealed, oriented polymer-containing material to its orientation temperature, heat shrinkage is produced almost to the original unstretched, i.e., pre-oriented dimensions. More particularly, the term “oriented”, as used herein, can refer to oriented films, wherein the orientation can be produced in one or more of a variety of manners.

As used herein, the term “package” refers to packaging materials configured around a product being packaged, and can include (but are not limited to) bags, pouches, trays, and the like.

As used herein, the term “polymer” refers to the product of a polymerization reaction, and can be inclusive of homopolymers, copolymers, terpolymers, etc. In some embodiments, the layers of a film can consist essentially of a single polymer, or can have still additional polymers together therewith, i.e., blended therewith.

As used herein, the term “proteolytic enzyme” refers to an enzyme that can be added to a marinade fluid to sever peptide bonds in proteins, and therefore tenderize a meat. Proteolytic enzymes suitable for use with the presently disclosed subject matter can include, but are not limited to, bromelain from pineapple and papain from papaya, achromopeptidase, aminopeptidase, ancrod, angiotensin converting enzyme, bromelain, calpain, calpain I, calpain II, carboxypeptidase A, carboxypeptidase B, carboxypeptidase G, carboxypeptidase P, carboxypeptidase W, carboxypeptidase Y, caspase, caspase 1, caspase 2, caspase 3, caspase 4, caspase 5, caspase 6, caspase 7, caspase 8, caspase 9, caspase 10, caspase 11, caspase 12, caspase 13, cathepsin B, cathepsin C, cathepsin D, cathepsin G, cathepsin H, cathepsin L, chymopapain, chymase, chymotrypsin a-, clostripain, collagenase, complement Clr, complement Cls, complement Factor D, complement Factor I, cucumisin, dipeptidyl peptidase IV, elastase (leukocyte), elastase (pancreatic), endoproteinase Arg-C, endoproteinase Asp-N, endoproteinase Glu-C, endoproteinase Lys-C, enterokinase, factor Xa, ficin, furin, granzyme A, granzyme B, HIV protease, IGase, kallikrein tissue, leucine aminopeptidase (general), leucine aminopeptidase (cytosol), leucine aminopeptidase (microsomal), matrix metalloprotease, methionine amiopeptidase, neutrase, papain, pepsin, plasmin, prolidase, pronase E, prostate specific antigen, protease (alkalophilic form), Streptomyces griseus, protease from Aspergillus, protease from Aspergillus saitoi, protease from Aspergillus sojae, protease (B. licheniformis) (Alkaline), protease (B. licheniformis) (Alcalase), protease from Bacillus polymyxa, protease from Bacillus sp, protease from Bacillus sp (Esperase), protease from Rhizopus sp., protease S, proteasomes, proteinase from Aspergillus oryzae, proteinase 3, proteinase A, proteinase K, protein C, pyroglutamate amiopeptidase, renin, rennin, streptokinase, subtilisin, thermolysin, thrombin, tissue plasminogen activator, trypsin, tryptase, urokinase, and combinations thereof.

As used herein, the term “rupturable” with regard to a seal can indicate the susceptibility of being broken without implying weakness. Thus, in referring to a rupturable seal between the films of a package, it can be meant that when so sealed the films are united together in a fluid impervious manner, and when the seal is broken or severed by delamination of the films from one another in the area of the seal, the films are separated apart from one another severing the seal while still maintaining the integrity of the individual films themselves. Thus, the rupturable seal in an intact state serves to maintain the integrity of the product chamber reservoir for maintaining fluid, semi-fluid, and/or solid products therein but in a broken or severed state allows for passage of these products between the films along a delaminated seal area.

As used herein, the term “seal” refers to any seal of a first region of an outer film surface to a second region of an outer film surface, including heat or any type of adhesive material, thermal or otherwise. In some embodiments, the seal can be formed by heating the regions to at least their respective seal initiation temperatures. The sealing can be performed by any one or more of a wide variety of means, including, but not limited to, using a heat seal technique (e.g., melt-bead sealing, thermal sealing, impulse sealing, dielectric sealing, radio frequency sealing, ultrasonic sealing, hot air, hot wire, infrared radiation, etc.).

As used herein, the phrases “seal layer”, “sealing layer”, “heat seal layer”, and “sealant layer”, refer to an outer film layer, or layers, involved in the sealing of the film to itself, another film layer of the same or another film, and/or another article that is not a film. It should also be recognized that in general, up to the outer 3 mils of a film can be involved in the sealing of the film to itself or another layer. With respect to packages having only fin-type seals, as opposed to lap-type seals, the phrase “sealant layer” generally refers to the inside film layer of a package, as well as supporting layers adjacent this sealant layer often being sealed to itself, and frequently serving as a food contact layer in the packaging of foods. In general, a sealant layer sealed by heat-sealing layer comprises any thermoplastic polymer. In some embodiments, the heat-sealing layer can comprise, for example, thermoplastic polyolefin, thermoplastic polyamide, thermoplastic polyester, and thermoplastic polyvinyl chloride. In some embodiments, the heat-sealing layer can comprise thermoplastic polyolefin.

As used herein, the phrase “thermoforming layer” refers to a film layer that can be heated and drawn into a cavity while maintaining uniform thinning, as opposed to films or film layers that lose integrity during the thermoforming process (e.g., polyethylene homopolymers do not undergo thermoforming with uniform thinning). In some embodiments, thermoforming layers can comprise, but are not limited to, polyamide, ethylene/propylene copolymer, and/or propylene homopolymer; in some embodiments, nylon 6, nylon 6/6, amorphous nylon, ethylene/propylene copolymer, and/or propylene homopolymer.

As used herein, the term “thermoplastic” refers to uncrosslinked polymers of a thermally sensitive material that flow under the application of heat or pressure.

As used herein, the term “tie layer” refers to any internal layer having the primary purpose of adhering two layers to one another. In some embodiments, tie layers can comprise any nonpolar polymer having a polar group grafted thereon, such that the polymer is capable of covalent bonding to polar polymers such as polyamide and ethylene/vinyl alcohol copolymer. In some embodiments, tie layers can comprise at least one member selected from the group including, but not limited to, modified polyolefin, modified ethylene/vinyl acetate copolymer, and/or homogeneous ethylene/alpha-olefin copolymer. In some embodiments, tie layers can comprise at least one member selected from the group consisting of anhydride modified grafted linear low density polyethylene, anhydride grafted low density polyethylene, homogeneous ethylene/alpha-olefin copolymer, and/or anhydride grafted ethylene/vinyl acetate copolymer.

As used herein, terminology employing a “/” with respect to the chemical identity of a copolymer (e.g., “an ethylene/alpha-olefin copolymer”), identifies the comonomers that are copolymerized to produce the copolymer. Such phrases as “ethylene alpha-olefin copolymer” are the respective equivalent of “ethylene/alpha-olefin copolymer.”

### III. On-Demand Meat Tenderizing Package

III.A. Generally

The presently disclosed subject matter will now be described more fully hereinafter with reference to the accompanying drawings, in which some, but not all embodiments are shown. Indeed, the presently disclosed subject matter can be embodied in many different forms and should not be construed as limited to the embodiments set forth herein.

The presently disclosed package can contain two or more compartments. One compartment can house one or more food additives, such as a marinade, and one compartment can house one or more food products, such as a meat. Applying pressure to at least one compartment can break a rupturable seal located between two compartments to distribute the food additive onto the food product. Thus, the presently disclosed subject matter achieves controlled application of a food additive to a food product. After sufficient marinating time, the marinated food product can be removed from package 10 and heated and/or cooked in an oven or microwave.

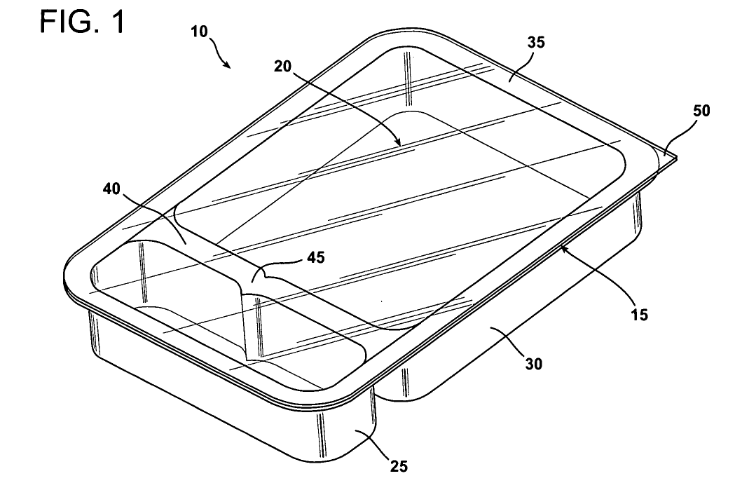

FIG. 1 is an illustrative view of presently disclosed package 10. Package 10 can be fabricated from first film 15 that is extruded and thermoformed to produce first compartment 25 and second compartment 30. Although two compartments are illustrated in FIG. 1, one of ordinary skill in the art would recognize that the presently disclosed subject matter can include package configurations with more than two compartments. Second film 20 is hermetically sealed to first thermoplastic film 15 through perimeter seal 35 such that compartmented package 10 is substantially air and liquid tight. Perimeter seal 35 extends around the perimeter of package 10 to create an airtight container. In some embodiments, first and second films 15 and/or 20 can be transparent so that the contents of the package can be viewed.

Continuing, first and second compartments 25 and 30 are separated by rupturable seal 40. Rupturable seal 40 is designed to break when exposed to a predetermined pressure to allow fluid communication between the contents of first and second compartments 25 and 30. Rupturable seal 40 is particularly configured to have a lower rupture pressure compared to perimeter seal 35. Thus, rupturable seal 40 can be intentionally broken when desired without undue effort, and without rupturing or tearing first and/or second films 15 and 20, and/or perimeter seal 35. In some embodiments, rupturable seal 40 contains one or more stress risers 45 to concentrate the direction of seal rupture. Particularly, stress riser 45 acts as an initiation or peel point in response to a pressure increase on the side of frangible seal 40 in which stress riser 40 is oriented. Thus, if package 10 was designed such that second compartment 30 was intended to be squeezed to break rupturable seal 40, the stress riser would be located on the side of frangible seal 40 closest to second compartment 30.

Once rupturable seal 40 has been broken, the contents of compartments 25 and 30 can be mixed by shaking, squeezing and the like. Accordingly, in order to mix the contents of compartments 25 and 30, the user needs merely to apply nominal pressure to package 10, particularly first compartment 25 such that rupturable seal 40 separating the compartments is broken. One of ordinary skill in the art would recognize that alternatively, a user can apply nominal pressure to second compartment 30, or both compartments 25 and 30 to break rupturable seal 40. The package contents can then be marinated for a desired amount of time without transferring the food items to another container.

In some embodiments, package 10 comprises an easy open feature, such as tab 50. In use, a user would merely peel tab 50 to separate first and second films 15 and 20 to have direct access to the items contained within package 10. One of ordinary skill in the art would recognize that any of a number of suitable opening means can be included within the presently disclosed subject matter. For example, ring pull tabs, zippers, and the like can be used.

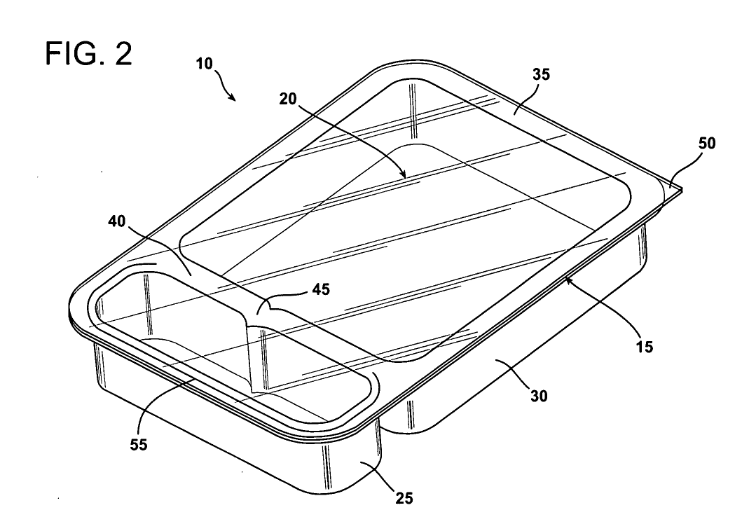

FIG. 2 depicts package 10, wherein secondary seal 55 is located surrounding first compartment 25 on all sides except the side containing rupturable seal 40. Alternatively, in some embodiments, secondary seal 55 can be configured to surround second compartment 30 on all sides except the side containing rupturable seal 40. In some embodiments, secondary seal 55 can be configured to surround both first and second compartments 25 and 30 on all sides except the side containing rupturable seal 40. Thus, at least one secondary seal 55 can be provided to add additional strength to one or more compartments of package 10.

III.B. Perimeter Seals

Perimeter seal 35 can be used to reliably contain the food additive and the food product in their respective compartments at normal operating pressures before, during, and after marinating. Perimeter seal 35 can also provide a margin of safety to contain the contents of package 10 in the event that the package is briefly dropped, bumped, and/or otherwise transiently exposed to higher pressures either before rupturable seal 40 is broken or afterwards.

FIGS. 1 and 2 illustrate that package 10 can be closed on all four edges. In some embodiments, one or more of the edges can comprise sealed edges. For example, if package 10 is originally formed from two separate sheets of plastic film material, the four edges can all be sealed edges. Thus, package 10 can be formed by heat sealing films 15 and 20 to form a package containing a food additive and a food product in first and second compartments 25 and 30. In some embodiments, the heat sealing operation can occur at the food packaging plant using a heat sealing machine designed for high speed operation. Heat sealing can occur by any of a number of techniques well known in the art, such as but not limited to, thermal conductance heat sealing, impulse sealing, ultrasonic sealing, dielectric sealing, and/or combinations thereof.

In some embodiments, the heat sealing machine includes a heated seal bar that contacts and compresses the two films to be heat sealed together to form perimeter seal 35. Generally, three variables can be considered in forming a heat seal: the seal bar temperature, the dwell time, and the sealing pressure. The seal bar temperature can refer to the surface temperature of the seal bar. The dwell time can refer to the length of time that the heated seal bar contacts the film to transfer heat from the seal bar to soften at least a portion of the films (e.g., the sealing layers of the films) so that they can be melded together. The sealing pressure can refer to the amount of force that squeezes the films together during this heat transfer. All of these variables can be modified accordingly in order to prepare a package suitable with the presently disclosed subject matter.

Because the heat sealing layers for much of the thermoplastic packaging films used in food packaging are based on relatively low-melting polyolefin thermoplastics (or similar melt-temperature thermoplastics), the heat sealing machines present in food packaging plants can be designed and set to operate with a seal bar temperature, a dwell time, and a sealing pressure in a range useful for such materials to permit the heat sealing machines to operate at high speeds to form strong seals.

Although the films of presently disclosed package 10 can be heat-sealed to form perimeter seal 35, the use of other adhesives or mechanical closures (e.g., clips) as desired or necessary is within the scope of the presently disclosed subject matter. Particularly, adhesives can be applied in a desired pattern, or sealed at a certain temperature (such as with a layer of ionomer) to define seal strength in a directly proportional fashion; i.e., more adhesive or higher temperature can create a stronger seal, while less adhesive or lower temperature can produce a weaker seal.

In some embodiments, perimeter seal 35 is not sealed until after package 10 is filled. Rather, first film 15 is formed into a compartmented support member having at least two compartments adapted to contain a food additive and a food product. The compartmented support member is then loaded with a charge of fresh or frozen food additive and a charge of food product. Second film 20 can be positioned to contact first film 15 along the perimeter of the package. A vacuum can then be applied to the compartments. Second film 20 can then be sealed around the perimeter of the compartmented support member to form perimeter seal 35.

III.C. Secondary Seal

In some embodiments, secondary seal 55 can be added to one or more ends of package 10. In some embodiments, secondary seal 55 can be added to first compartment 25 of package 10, the compartment containing the food additive. Secondary seal 55 can act as a reassurance to prevent leakage of package 10. Thus, at least one secondary seal 55 can be provided to add additional strength to one or both compartments of package 10. In some embodiments, first compartment 25 and/or second compartment 30 can be strengthened with a secondary seal by using heat seal equipment having differential heating capabilities. That is, first compartment 25 can be heated with a higher temperature seal bar compared to second compartment 30 to reinforce the food additive end.

In some embodiments, secondary seal 55 can be made after perimeter seal 35 is made. In some embodiments, secondary seal 55 can be made after package 10 has been exposed to a vacuum station. Thus, secondary seal 55 can be made using a separate heat seal bar for one end seal on one or both compartment sides (e.g., the marinade compartment side) of package 10.

III.D. Rupturable Seal

Presently disclosed marinade package 10 contains one or more rupturable seals 40 designed to break when exposed to a predetermined pressure, allowing fluid communication between compartments 25 and 30. Rupturable seal 40 is particularly configured to have a lower rupture pressure compared to perimeter seal 35 and secondary seal 55 such that the perimeter and secondary seals are unaffected by the rupture of rupturable seal 40. In addition, rupturable seal 40 is configured to rupture in a controlled manner across a sufficient area to provide a relatively low-pressure movement of a flowable food additive (such as marinade) from one compartment of package 10 to another.

Rupturable seal 40 can be located between first and second compartments 25 and 30 and can join films 15 and 20. In some embodiments, the distance between rupturable seal 40 and one end of the package is between about one-quarter and one-third of the length of the package. Of course, rupturable seal 40 can be placed at any suitable location within package 10 and its position will depend upon the relative amounts of materials to be packaged as well as the number of compartments located in package 10.

Thus, rupturable seal 40 hermetically separates first compartment 25 and second compartment 30. When at least one compartment is manipulated mechanically or by hand, such as if pressed against a hard surface or squeezed between a user's fingers and thumbs, rupturable seal 40 hydraulically breaks, thereby producing a pathway allowing fluid communication between first compartment 25 and second compartment 30. Accordingly, in order to mix the products in the different compartments, the user needs merely to apply nominal pressure to compartments 25 and 30 such that rupturable seal 40 separating the compartments is broken. Compartments 25 and 30 are surrounded by perimeter seal 35 that does not rupture under nominal pressures or upon the rupture of rupturable seal 40. Once the rupturable seal has been broken, the package contents can be mixed by shaking, squeezing and/or the like. The package contents can then be marinated for a desired amount of time, without transferring the food items to another container. However, if desired, the contents of package 10 can be removed and transferred to an alternate container during marinating.

Rupturable seal 40 can be formed by any of a number of various techniques known in the art. Particularly, it will be understood that there are a number of ways of making rupturable seal 40 in accordance with the presently disclosed subject matter, including, but not limited to, one or more of zone patterning, adhesive, ultrasonic welding, thermal bonding, crimping, cohesives, compression, nipping, needle punching, sewing, hydroentangling, and the like. For example, in some embodiments, rupturable seal 40 can be formed of a pattern of printed ink that prevents the package films from heat sealing at an inked portion, such that the amount of inked portions in the ink pattern determine the strength of the seal. In some embodiments, rupturable seal 40 can be fabricated by means of a discontinuity within the seal width. For example, one discontinuity within rupturable seal 40 can include one or more stress concentrators 45 having an inflection point that is more responsive to the interior bag pressure force than other portions that are relatively straight or smoothly curved.

Continuing, in some embodiments, rupturable seal 40 can be comprised of incompatible polymer blends. Thus, the seal strengths of rupturable seal 40 can depend on the particular polymer blend used. For example, common polymer blends can include, but are not limited to, zinc neutralized ethylene-acid (EMAA or EAA) copolymer ionomer (e.g., Surlyn 1650) with ethylene vinyl acetate (EVA) copolymer (e.g., Elvax 3120) and optionally with or without polybutylene; polypropylene with ethylene vinyl acetate; sodium neutralized EMAA, EMAA, and/or EVA; EVA and polystyrene or polystyrene copolymer (e.g., K-Resin® or Styralux®); and/or EVA with polybutylene. In some embodiments, the EVA can be replaced with other polyethylenes, as would be apparent to one of ordinary skill in the art.

In some embodiments, the strength of rupturable seal 40 can be manipulated by the temperature, dwell time and/or pressure of the heat seal bar, depending on the type and thickness of the sealant being applied. It is to be understood that the pressure required to separate rupturable seal 40 can depend upon the width of the sealed area at the inner end thereof. Thus, the size and configuration of rupturable seal 40 can be altered to vary the pressure within the sealed enclosure required to rupture the seal.

In some embodiments, rupturable seal 40 contains one or more stress risers 45. The provision of such stress risers 45 on rupturable seal 40 tends to create peel initiation points at which point or points rupturable seal 40 begins its opening (or peel), in response to a pressure increase on the side of rupturable seal 40 wherein stress riser 45 is oriented. The developing front of a pressure increase against a non-linear barrier, such as that of rupturable seal 40 with stress risers 45, is well known to have a region of maximum concentration of pressure in the region of maximum inflection of rupturable seal 40 with stress riser 45 when the inflection point is oriented to extend in the direction of the pressure front. The concentration of force of the pressure front can initiate rupturable seal 40 opening, or peel, at stress riser 45. When pressure is applied to first compartment 25, the pressure begins peeling open rupturable seal 40, starting at the point of chevron.

It is not necessary that stress riser 45 have any particular configuration, only that the initiation of rupturable seal 40 opening is enhanced as the inflection point as stress riser 45 becomes sharper. Thus, gently curved rupturable seal 40 would tend to concentrate force at a particular point less intensely than would a rupturable seal having an inflection point that resembled a saw tooth.

Accordingly, as illustrated in FIGS. 1 and 2, in some embodiments, stress concentrator 45 can define a substantially V-shaped central vent in rupturable seal 40, having the tip of the “V” ending before the outer edge of the seal. Because the surface area of rupturable seal 40 is reduced at the tip of stress concentrator 45, there exists a weakened portion in the seal at that location. As would be readily understood by one of ordinary skill in the art, the shape of stress concentrator 45 can be appropriately changed in accordance with the presently disclosed subject matter.

III.E. Opening Means

Although the presently disclosed subject matter can find use in permanent and/or reusable cooking systems, it is primarily intended for disposable use. That is, the presently disclosed subject matter can be targeted to single-use applications wherein prepared, cooked, or uncooked food items can be placed in package 10 and marinated. After sufficient time, the marinated food items can be removed from package 10 and positioned in a microwave oven or conventional oven to heat and/or cook the food. Emptied package 10 can then be discarded after one use.

In some embodiments, the presently disclosed subject matter can include an opening means integrally formed in package 10 for accessing the food items contained therein. It should be appreciated that the opening means can be incorporated into package 10 prior to or after filling. Various types of opening means are known in the art for such purposes. Thus, one of ordinary skill in the art can readily appreciate the wide variety of opening means that can be included in package 10. For example, in some embodiments, package 10 can comprise one or more opening means, such as a pull tab, zipper, tear strip, plastic reclosable fastener, and the like located at various positions on package 10. Hence, a person of ordinary skill in the art would appreciate that the opening means can be prepared in a variety of configurations without departing from the scope of the presently disclosed subject matter. However, in some embodiments, no opening means is formed in package 10, and users can access the packaged products by cutting with scissors or a knife.

Thus, in some embodiments, package 10 can include an opening means that comprises an integral tear-off portion or tear notch. The tear notch can provide access to at least one of first or second compartments 25 or 30 of package 10. For example, in some embodiments, a tear notch can be formed near an edge of package 10 for accessing the food items contained therein, although it could be located elsewhere. Suitable film combinations can provide directional tear properties such that a pre-notched package can be torn, opening a straight line in either the machine or transverse direction. Such tear properties allow for flexibility in package 10 configurations and design.

In some embodiments, package 10 can incorporate a peelable seal between a combination of one or more of flexible films, webs, substrates, or supports. The layer of the peelable film that primarily facilitates the easy-open, peelable seal can be referred to as the “peelable layer” or “separation layer.” If the film is a monolayer film, the film itself can be considered the peelable layer. If the peelable layer is an outer layer of a multi-layer film, then the peelable layer can be a sealant layer (e.g., heat-seal layer) of the film. In some embodiments, the peelable layer can be an internal layer of a multi-layer film wherein one or more layers of a film can be hand-peeled away (i.e., delaminated) from the remaining layers of the film. Examples include thermoforming and vacuum skin packaging methods known in the art. For example, the lower web or support (e.g., “formed web”) can be heated and deep-drawn to form a receptacle for the item to be packaged. Once the item is placed on the support, the upper web (e.g., “non-formed web”) can be drawn over the item and peelably sealed to the peripheral edges of the support. The seal can be formed using heated sealing bars, platens, or frames to apply heat and pressure to the top and bottom webs in the seal area. To open an easy-open package, the user simply grasps a portion of second film 20 (such as, for example, tab 50 depicted in FIGS. 1 and 2) and pulls or “peels” it away from first film 20 and/or a support, thereby causing the peelable seal to fail.

Incorporation of one or more opening means within package 10 of the presently disclosed subject matter also provides an added safety measure to the consumer. The consumer can easily open package 10 using an opening means, rather than using a cutting device to cut or tear into the package.

### IV. Manufacture of the Package

IV.A. Generally

The presently disclosed subject matter is directed to a multi-compartment package that can be filled with two or more products that are to be stored separately from each other until they are desired to be intermixed. The compartments are separated by one or more rupturable seals sealed between the films forming the package. The rupturable seal can be ruptured under pressure allowing the products in the compartments to intermix.

In some embodiments, to make package 10, the items to be packaged (e.g., the food additive and/or food product) can be placed onto thermoformed first film 15. For example, a frozen charge of marinade and a charge of meat can be placed into first and second compartments 25 and 30, respectively. Second film 20 can then be placed over first film 15 such that the sealant layer of second film 20 contacts first film 15. In some embodiments, second film 20 can be supplied from a larger web, for example, from a roll that is unwound to supply film as needed. The excess first and/or second film 15 and/or 20 can be trimmed by a cutting operation. Further, if second film 20 is supplied from a roll, portions can be severed from the web after or simultaneously with the heat-welding of second film 20 to first film 15. In some embodiments, second film 20 can be severed by a conventional cutting device (e.g., a sharp cutting instrument or a thermal cutting device such as a heated wire or heated blade).

A heated bar or member engages the perimeter of first film 15 to compress second film 20 against first film 15. As set forth herein, the sealing of the second film 20 to first film 15 can be by one or more of the well known heat sealing methods, including (but not limited to) thermal conductance sealing (as described above), impulse sealing, ultrasonic sealing, dielectric sealing, and the like. The resulting heat transfer and compression allows the sealant layer of second film 20 and the surface layer of first film 15 to soften and intermix with one another. The heat from the sealing operation can also initiate shrinking to reduce the amount of wrinkles or waves that may otherwise form in first film 15 and/or second film 20.

IV.B. Films

In some embodiments, package 10 can be fabricated from first film 15 that is extruded and thermoformed to produce first compartment 25 and second compartment 30. Thermoforming is well known in the packaging art, and is the process whereby a thermoplastic web is heat softened and reshaped to conform to the shape of a cavity in a mold. Suitable thermoforming methods, for example, include a vacuum forming or plug-assist vacuum forming method. In a vacuum forming method, the first web is heated, for example, by a contact heater, and a vacuum is applied beneath the web causing the web to be pushed by atmospheric pressure down into a preformed mold. In a plug-assist vacuum forming method, after the first or forming web has been heated and sealed across a mold cavity, a plug shape similar to the mold shape impinges on the forming web and, upon the application of vacuum, the forming web transfers to the mold surface.

It should be noted herein that first film 15 can be a “bottom” web, i.e., in normal usage, the package can rest on first film 15 such that the web comprises the bottom of package 10. Likewise, second film 20 can be a “top” web, i.e., in normal usage, the package can be positioned such that the web comprises the top of the package. This description is for convenience in understanding the presently disclosed subject matter. Nevertheless, those skilled in the art will understand, after a review of the presently disclosed subject matter, that the package can be manufactured, stored, shipped, and/or displayed in any suitable orientation. For example, the package can be placed on a supporting surface such that the thermoformed web functions as the top of the package and the covering web functions as the bottom of the package.

In some embodiments, first and second films 15 and 20, respectively, are multilayered structures having various layers that are produced using coextrusion techniques and lamination techniques well known in the art. Thus, the films can be coextruded or laminated and can be adhered together with a coextruded tie layer such as ethylene vinyl acetate, an ionomer, anhydride grafted ethylene vinyl acetate, low density polyethylene and/or linear low density polyethylene. The typical film-to-film bond from lamination is made by adhering the films together with a thin layer of polyurethane coating on an adhesive laminator. The lamination can also be accomplished by extrusion lamination or extrusion coating with an adhesive coextrusion tie layer type resin at the bond interface. Thus, films of the presently disclosed subject matter can be manufactured by coextrusion methods and adhesive lamination methods, such as those disclosed in U.S. Pat. No. 6,769,227 to Mumpower, the content of which is incorporated herein in its entirety by reference thereto. Accordingly, films of the presently disclosed subject matter can be made by any suitable process, including coextrusion, lamination, extrusion coating, and combinations thereof.

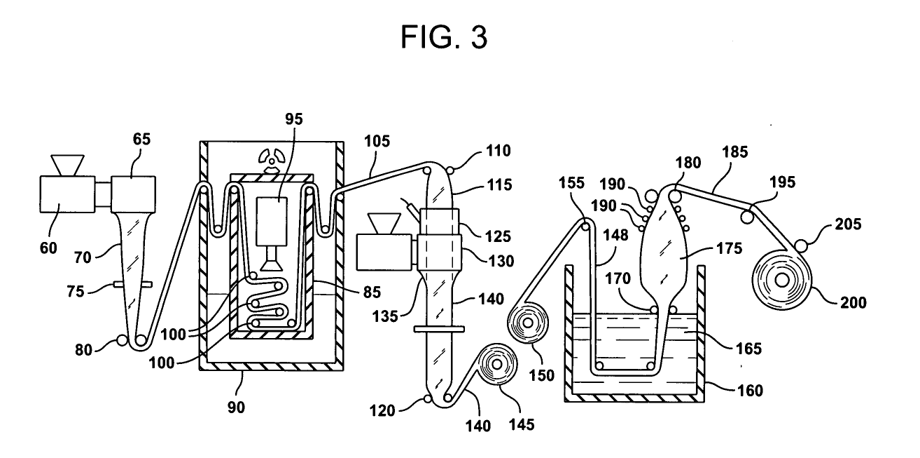

FIG. 3 illustrates a schematic view of a process that can be used for making films according to the presently disclosed subject matter. However, any of a variety of processes well known in the art can be used to make the disclosed films. As illustrated in FIG. 3, solid polymer beads (not illustrated) are fed to a plurality of extruders 60 (for simplicity, only one extruder is illustrated). Inside extruders 60, the polymer beads are forwarded, melted, and degassed, following which the resulting bubble-free melt is forwarded into die head 65, and extruded through an annular die, resulting in tubing 70 that is, in some embodiments, about 10 to 20 mils thick.

After cooling or quenching by water spray from cooling ring 75, tubing 70 is collapsed by pinch rolls 80, and is thereafter fed through irradiation vault 85 surrounded by shielding 90, where tubing 70 is irradiated with high energy electrons (i.e., ionizing radiation) from iron core transformer accelerator 95. Tubing 70 is guided through irradiation vault 85 on rolls 100. In some embodiments, tubing 70 is irradiated to a level of from about 40 kGy to about 120 kGy.

After irradiation, irradiated tubing 105 is directed through pinch rolls 110, following which irradiated tubing 105 is slightly inflated, resulting in trapped bubble 115. However, at trapped bubble 115, the tubing is not significantly drawn longitudinally, as the surface speed of nip rolls 120 are about the same speed as pinch rolls 110. Furthermore, irradiated tubing 105 is inflated only enough to provide a substantially circular tubing without significant transverse orientation, i.e., without stretching.

Slightly inflated, irradiated tubing 105 is passed through vacuum chamber 125, and thereafter forwarded through coating die 130. Annular coating stream 135 is melt extruded from coating die 130 and coated onto slightly inflated, irradiated tube 115, to form two-ply tubular film 140. Coating stream 135 can comprise an O₂-barrier layer, which does not pass through the ionizing radiation. Further details of the above-described coating step are generally as set forth in U.S. Pat. No. 4,278,738, to Brax et al., which is hereby incorporated by reference thereto in its entirety.

After irradiation and coating, two-ply tubing film 140 is wound up onto windup roll 145. Thereafter, windup roll 145 is removed and installed as unwind roll 150, on a second stage in the process of making the tubing film as ultimately desired. Two-ply tubular film 140, from unwind roll 150, is unwound and passed over guide roll 155, after which two-ply tubular film 140 passes into hot water bath tank 160 containing hot water 165. The now collapsed, irradiated, coated tubular film 185 is immersed in hot water 165 (in some embodiments, having temperature of about 185° F. to 210° F.) for a period of from about 10 to about 100 seconds, i.e., for a time period in order to bring the film up to the desired temperature for biaxial orientation.

Thereafter, irradiated tubular film 140 is directed through nip rolls 170, and bubble 175 is blown, thereby transversely stretching tubular film 140. Furthermore, while being blown, i.e., transversely stretched, nip rolls 180 draw tubular film 140 in the longitudinal direction, as nip rolls 180 have a surface speed higher than the surface speed of nip rolls 170. As a result of the transverse stretching and longitudinal drawing, irradiated, coated biaxially-oriented blown tubing film 140 is produced, the blown tubing in some embodiments having been both stretched in a ratio of from about 1:1.5 to about 1:6, and drawn at a ratio of from about 1:1.5 to about 1:6; in some embodiments, the stretching and drawing are each performed a ratio of from about 1:2 to about 1:4. The result is a biaxial orientation of from about 1:2.25 to about 1:36, in some embodiments, from about 1:4 to about 1:16. While bubble 175 is maintained between pinch rolls 170 and 180, blown tubing film 185 is collapsed by rollers 190, and thereafter conveyed through nip rolls 180 and across guide roll 195, and then rolled onto wind-up roll 200. Idler roll 205 assures a good wind-up.

The films used to form the disclosed packages can be provided in sheet or film form and can be any of the films commonly used for this type of packaging. In some embodiments, however, the film can be a commercially available multilayer film having a sealant layer, a barrier layer, and one or more abuse layers.

Thus, in some embodiments, the film of the disclosed packages can comprise one or more barrier layers. Such barrier layers can include, but are not limited to, ethylene/vinyl alcohol copolymer, polyvinylidene chloride, polyalkylene carbonate, polyamide, polyethylene naphthalate, polyester, polyacrylonitrile, and combinations thereof, as known to those of skill in the art. In some embodiments, the barrier layer can comprise either EVOH or polyvinylidene chloride, and the PVDC can comprise a thermal stabilizer (i.e., a HCl scavenger, such as epoxidized soybean oil) and/or a lubricating and/or processing aid, which are well known in the art.

In some embodiments, the film of the disclosed packages can comprise one or more seal layers. Such seal layers can include, but are not limited to, the genus of thermoplastic polymers, including thermoplastic polyolefin, polyamide, polyester, polyvinyl chloride, homogeneous ethylene/alpha-olefin copolymer, ethylene/vinyl acetate copolymer, ionomer, and combinations thereof.

In some embodiments, the film of the disclosed packages can comprise one or more tie layers. In some embodiments, tie layers can comprise any nonpolar polymer having a polar group grafted thereon, so that the polymer is capable of covalent bonding to polar polymers, such as polyamide and ethylene/vinyl alcohol copolymer. In some embodiments, tie layers can comprise at least one member of the group including, but not limited to, modified polyolefin, modified ethylene/vinyl acetate copolymer, homogeneous ethylene/alpha-olefin copolymer, and combinations thereof. In some embodiments, tie layers can comprise at least one member selected from the group including, but not limited to, anhydride modified grafted linear low density polyethylene, anhydride grafted low density polyethylene, homogeneous ethylene/alpha-olefin copolymer, and/or anhydride grafted ethylene/vinyl acetate copolymer.

In some embodiments, the film of the disclosed packages can comprise one or more abuse layers. In some embodiments, abuse layers can comprise any polymer, so long as the polymer contributes to achieving an integrity goal and/or an appearance goal. In some embodiments, the abuse layer can include, but is not limited to, polyamide, ethylene/propylene copolymer, nylon 6, nylon 6/6, amorphous nylon, and combinations thereof.

In some embodiments, the film of the disclosed package can comprise one or more bulk layers to increase the abuse-resistance, toughness, modulus, etc., of the film. In some embodiments, the bulk layer can comprise polyolefin, including but not limited to, at least one member selected from the group consisting of ethylene/alpha-olefin copolymer, ethylene/alpha-olefin copolymer plastomer, low density polyethylene, and linear low density polyethylene.

The polymer components used to fabricate films according to the presently disclosed subject matter can also comprise appropriate amounts of other additives normally included in such compositions. For example, slip agents (such as talc), antioxidants, fillers, dyes, pigments and dyes, radiation stabilizers, antistatic agents, elastomers, and the like can be added to the disclosed films.

Generally, the films employed in the presently disclosed subject matter can be multilayer or monolayer, although, of course, those films defined as delaminatable, multilayer films must include at least two layers. Typically, the films employed will have two or more layers in order to incorporate a variety of properties, such as, for example, sealability, gas impermeability and toughness, into a single film.

In some embodiments, at least a portion of at least one film of the presently disclosed subject matter can be irradiated to induce crosslinking. In the irradiation process, the film is subjected to one or more energetic radiation treatments, such as corona discharge, plasma, flame, ultraviolet, X-ray, gamma ray, beta ray, and high energy electron treatment, each of which induces cross-linking between molecules of the irradiated material. The irradiation of polymeric films is disclosed in U.S. Pat. No. 4,064,296, to Bornstein et al., which is hereby incorporated in its entirety by reference thereto.

Films of the presently disclosed subject matter can have any total thickness desired, so long as the films provide the desired properties for the particular packaging operation in which the film is used. Final web thicknesses can vary, depending on process, end use application, and the like. Typical thicknesses range between 0.1 to 20 mils, in some embodiments between 0.3 and 15 mils, in some embodiments 0.5 to 10 mils, in some embodiments 1 to 8 mils, in some embodiments 3 to 6 mils, such as 4 to 5 mils. In some embodiments, top webs can have a thickness of between 2 and 5 mils, and bottom webs can have a thickness of between 5 and 10 mils.

In some embodiments, the film according to the presently disclosed subject matter comprises a total of from about 4 to about 20 layers; in some embodiments, from about 4 to about 12 layers; and in some embodiments, from about 5 to about 9 layers. Thus, in some embodiments, the disclosed film can comprise 1, 2, 3, 4, 5, 6, 7, 8, 9, 10, 11, 12, 13, 14, 15, 16, 17, 18, 19, or 20 layers. Accordingly, the film of the disclosed package can have any total thickness desired, so long as the film provides the desired properties for the particular packaging operation in which the film is used, e.g. optics, modulus, seal strength, and the like.

In some embodiments, first and second films 15 and 20 can be transparent (at least in the non-printed regions) so that the packaged articles are visible through the films. “Transparent” as used herein means that the material transmits incident light with negligible scattering and little absorption, enabling objects (e.g., packaged food or print) to be seen clearly through the material under typical unaided viewing conditions (i.e., the expected use conditions of the material). The transparency (i.e., clarity) of the film can be at least about any of the following values: 20%, 25%, 30%, 40%, 50%, 65%, 70%, 75%, 80%, 85%, and 95%, as measured in accordance with ASTM D1746.

IV.C. Sealing

As set forth in detail herein above, package 10 comprises perimeter seal 35 and rupturable seal 40. In some embodiments, package 10 can further comprise secondary seal 55. In some embodiments, the perimeter seals can be formed using a heat sealing machine that includes a heated seal bar that contacts and compresses films 15 and 20 together to form perimeter seal 35. After compression for a desired amount of time, the heating bar can then be removed to allow the sealed area to cool and form a sealed bond. The resulting perimeter seal 35 can extend continuously around the outside edge of package 10 to hermetically seal or enclose the food product and/or food additive housed therein. In this manner, first and second films 15 and 20 can form a substantially gas-impermeable enclosure to protect the food product and/or food additive from contact with the surrounding environment including atmospheric oxygen, dirt, dust, moisture, liquid, microbial contaminates, and the like. In some embodiments, the meat and/or marinade can be packaged in a modified atmosphere package to extend the shelf life or bloom-color life.

The resulting perimeter seal 35 between first and second films 15 and 20 can be sufficiently strong to withstand the expected use conditions. For example, the bond strength of perimeter seal 35 can be at least about any of the following values: 0.5, 0.6, 0.7, 0.8, 0.9. 1.0, 1.3, 1.5, 1.8, 2, 2.5, 3, 3.5, 4, 4.5, 5, 5.5, 6, 6.5, 7, 7.5, and 8 pounds/inch. The term “heat seal bond strength” as used herein can refer to the amount of force required to separate the sealant layer of second film 20 from first film 15 to which the sealant layer has been sealed, as measured in accordance with ASTM F88-94 where the Instron tensile tester crosshead speed is 5 inches per second, using five, 1-inch wide representative samples.

In some embodiments, the seal around first compartment 25 and/or second compartment 30 can be strengthened by incorporating secondary seal 55 surrounding the compartment on all sides, except the side adjacent to the rupturable seal. Thus, secondary seal 55 can be positioned about the perimeter of package 10, adjacent to at least one of the two compartments. In some embodiments, secondary seal 55 can be prepared by using heat seal equipment having differential heating capabilities compared to the perimeter seal. That is, one or more compartments can be heated with a higher temperature seal bar compared to the perimeter seal to reinforce the one or more compartments.

Rupturable seal 40 can be formed by any of a number of various techniques. Particularly, it will be understood that rupturable seal 40 can be made using one or more of zone patterning, adhesive, ultrasonic welding, thermal bonding, crimping, cohesives, compression, nipping, needle punching, sewing, hydroentangling, and the like. A combination of these methods can also be used.

### V. Package Contents

V.A. Food Product

As set forth in detail herein above, in some embodiments second compartment 30 of package 10 can comprise a food product, such as a cut of meat. Examples of food products that are suitable for use with the presently disclosed subject matter can include, but are not limited to, beef, birds such as poultry (including chicken, duck, goose, turkey, and the like), buffalo, camel, crustacean (including shellfish, clams, scallops, mussels, oysters, lobster, crayfish, crab, shrimp, prawns, and the like), dog, fish (including salmon, trout, eel, cod, herring, plaice, whiting, halibut, turbot, ling, squid, tuna, sardines, swordfish, dogfish, shark, and the like), game (including deer, eland, antelope, and the like), game birds (such as pigeon, quail, doves, and the like), goat, hare, horse, kangaroo, lamb, marine mammals (including whales and the like), amphibians (including frogs and the like), monkey, pig, rabbit, reptiles (including turtles, snakes, alligators, and the like), and/or sheep. In some embodiments, the food product can be whole, diced, minced, shaved, cut into strips, and/or formed into meatballs.

In some embodiments, meat substitutes can be used and are included under the term “meat”. Such meat substitutes can approximate the aesthetic qualities and/or chemical characteristics of certain types of meat. The meat substitutes can include, but are not limited to, seitan, rice, mushrooms, legumes, tempeh, textured vegetable protein, soy concentrate, mycoprotein-based Quorn, modified defatted peanut flour, and/or pressed tofu to make the meat substitute look and/or taste like chicken, beef, lamb, ham, sausage, seafood, and the like.

In some embodiments, the food product can comprise one or more vegetables. Vegetables that are particularly suited for use with the presently disclosed subject matter can include, but are not limited to, artichokes, asparagus, beans, bean sprouts, beets, broccoli, cauliflower, cabbage, carrots, celery, corn, collards, eggplant, green peppers, kale, leeks, mushrooms, mustard greens, onions, peas, potatoes, radishes, red peppers, rhubarb, spinach, squash, sweet potatoes, turnips, water chestnuts, watercress, yams, yellow peppers, and/or zucchini. In some embodiments, the vegetable can be diced, minced, shaved, and/or cut into strips.

Accordingly, the food product suitable for use with the presently disclosed subject matter is not particularly limited. The presently disclosed methods and package can be applied to raw (i.e., uncooked) food products, partially cooked food products, and/or pre-cooked products, where the cooking process is intended to cook, completely cook, and/or re-heat the food product. Thus, the food product selected can be any type that is suitable for consumption. The food product can be non-rendered, non-dried, raw, and can comprise mixtures of whole muscle meat formulations. Whole meat pieces can be fresh, although frozen or semi-frozen forms can also be used. Since freezing affects the tenderness of meat by rupturing intrafibrillar tissue as a result of ice crystal formation, the increased tenderness resulting from freezing can be taken into account when using such products in the package and methods described herein.

V.B. Food Additive

The amount of marinade to be used in the presently disclosed subject matter depends on the type and added amount of food additive. The food additive can be in any form including, but not limited to, liquid, paste, powder, and/or combinations thereof. In some embodiments, the food additive can be in the form of liquid or powder from the standpoint of handleability, preservability, and the like. If the food additive of the presently disclosed subject matter is used in liquid form, it can be in the form of solution or dispersion in water or an aqueous liquid or in the form of solution or dispersion in fatty oil. In some embodiments, the food additive can be frozen when added to package 10 in order to allow heat sealing mechanisms to function appropriately. That is, when a liquid food additive is added to package 10, the liquid nature of the food additive can interfere with the heat sealing process, producing a non-hermetic seal.

In some embodiments, the food additive can comprise one or more enzymatic tenderizers to form a tenderized meat product. Particularly, one or more proteolytic enzymes can be added to the food additive to sever peptide bonds in proteins, and therefore tenderize the meat. Proteolytic enzymes suitable for use with the presently disclosed subject matter can include, but are not limited to, bromelain from pineapple and papain from papaya, achromopeptidase, aminopeptidase, ancrod, angiotensin converting enzyme, bromelain, calpain, calpain I, calpain II, carboxypeptidase A, carboxypeptidase B, carboxypeptidase G, carboxypeptidase P, carboxypeptidase W, carboxypeptidase Y, caspase, caspase 1, caspase 2, caspase 3, caspase 4, caspase 5, caspase 6, caspase 7, caspase 8, caspase 9, caspase 10, caspase 11, caspase 12, caspase 13, cathepsin B, cathepsin C, cathepsin D, cathepsin G, cathepsin H, cathepsin L, chymopapain, chymase, chymotrypsin a-, clostripain, collagenase, complement Clr, complement Cls, complement Factor D, complement Factor I, cucumisin, dipeptidyl peptidase IV, elastase (leukocyte), elastase (pancreatic), endoproteinase Arg-C, endoproteinase Asp-N, endoproteinase Glu-C, endoproteinase Lys-C, enterokinase, factor Xa, ficin, furin, granzyme A, granzyme B, HIV protease, IGase, kallikrein tissue, leucine aminopeptidase (general), leucine aminopeptidase (cytosol), leucine aminopeptidase (microsomal), matrix metalloprotease, methionine amiopeptidase, neutrase, papain, pepsin, plasmin, prolidase, pronase E, prostate specific antigen, protease (alkalophilic form), Streptomyces griseus, protease from Aspergillus, protease from Aspergillus saitoi, protease from Aspergillus sojae, protease (B. licheniformis) (Alkaline), protease (B. licheniformis) (Alcalase), protease from Bacillus polymyxa, protease from Bacillus sp, protease from Bacillus sp (Esperase), protease from Rhizopus sp., protease S, proteasomes, proteinase from Aspergillus oryzae, proteinase 3, proteinase A, proteinase K, protein C, pyroglutamate amiopeptidase, renin, rennin, streptokinase, subtilisin, thermolysin, thrombin, tissue plasminogen activator, trypsin, tryptase, urokinase, and combinations thereof.

In some embodiments, the food additive can comprise additional components, including but not limited to, bactericides, fungicides or other preservatives, wetting agents (e.g., a Tween), antioxidants, viscosity control agents (e.g. gums), brine (e.g., sodium chloride, phosphates, dextrose), curing agents (e.g., nitrites, sugars, erythorbate), flavoring agents (e.g., herbs, spices, and liquid smoke), and the like.

### VI. Methods of Using the Disclosed Marinade Bag

As set forth in detail hereinabove, presently disclosed package 10 can be prepared such that first film 15 is formed into first and second compartments 25 and 30. A food product (e.g., a meat) can then be placed in second compartment 30, and a frozen food additive (e.g., a marinade) can be placed in first compartment 25. One of ordinary skill in the art will recognize that in some embodiments, the marinade can be placed in second compartment 30 and the meat can be placed in first compartment 25. Second film 20 can then hermetically seal the food product and the food additive within package 10.

Thus, in some embodiments, the presently disclosed subject matter is directed to a package for marinating and/or heating one or more food items. In some embodiments, package 10 can comprise a first thermoformed film formed into a compartmented support member having at least two compartments and a second thermoplastic film disposed on the thermoformed film. Two or more food items, such as for example a food product and a food additive, can then be disposed in each of the compartments of the thermoformed film. The first and second films can then be sealed together to form a perimeter seal around the perimeter of the package. At least one rupturable seal connects the first and second compartments such that the rupturable seal has seal strength less than the seal strength of the perimeter seal. The rupturable seal joins the thermoformed film and the second film between the compartments. In addition, the rupturable seal remains intact until an external force is applied to at least one of the compartments and the items can be intermixed.

Particularly, at a desired time, a user can grip package 10, and using his thumbs or a hard object, emit pressure on one or both of first and/or second compartments 25 and/or 30. Upon the increased pressure, rupturable seal 40 will fail, allowing the contents of first and second compartments 25 and 30 to freely mix. In some embodiments, secondary seal 55 can provide a safety feature to ensure that perimeter seal 35 around the particular compartment that the user has emitted pressure upon does not rupture to allow the contents of first and/or second compartments 25, 30 to leak. In order to facilitate mixing, the user can shake or rotate package 10 to fully mix the food product and food additive.

Package 10 can then be marinated for a desired amount of time. In some embodiments, package 10 can be incubated a sufficient time to allow the food product to tenderize to a desired amount. Thus, in some embodiments, the presently disclosed subject matter is directed to a method of controlling the level of food additive imparted to a food product. The method comprises forming a first thermoformable thermoplastic film into a compartmented support member having at least two compartments. The compartmented support member is then loaded with a charge of frozen food additive into the first compartment and a charge of a food product into the second compartment. A vacuum is then applied to the first and second compartments. A second thermoplastic film is then indexed into alignment with the compartmented first support member along the periphery and along an interior partition line between the first and second compartments. In addition, the package has an interior heat seal that ruptures in response to an applied external pressure.

### EXAMPLES

The following Examples provide illustrative embodiments. In light of the present disclosure and the general level of skill in the art, those of skill will appreciate that the following Examples are intended to be exemplary only and that numerous changes, modifications, and alterations can be employed without departing from the scope of the presently claimed subject matter.

Several film structures in accordance with the presently disclosed subject matter and comparatives are identified herein below.

TABLE 1
Resin Identification

| Material | Trade name Or | |
|---|---|---|
| Code | Designation | Source(s) |
| A | Appeel 72D811 | E. I. du Pont de Nemours |
| | | and Company |
| | | (Wilmington, Delaware, |
| | | United States of America) |
| B | ESCORENE LD-200.48 | ExxonMobile (Fairfax, |
| | | Virginia, United States of |
| | | America) |
| C | TAFMER P-0480 | Mitsui Chemical, Inc. |
| | | (New York, New York, |
| | | United States of America) |
| D | EXCEED 4518PA | ExxonMobile (Fairfax, |
| | | Virginia, United States of |
| | | America) |
| E | PX3236 | Equistar Chemicals |
| | | (Houston, Texas, United |
| | | States of America) |
| F | Grivory G21 Natural | EMS, Inc. (Sumter, South |
| | | Carolina, United States of |
| | | America) |
| G | AEGIS H100WP | Honeywell International, |
| | | Inc. (Morristown, New |
| | | Jersey, United States of |
| | | America) |
| H | AEGIS H100QP | Honeywell International, |
| | | Inc. (Morristown, New |
| | | Jersey, United States of |
| | | America) |
| I | EVAL H171B | EVALCA (Pasadena, |
| | | Texas, United States of |
| | | America) |
| J | SOARNOL ET3803 | Nippon Gohsei (Tokyo, |
| | | Japan) |
| K | 1080864S | Clariant International Ltd. |
| | | (Muttenz, Switzerland) |
| L | GRILON MB 3361 FS | EMS, Inc. (Sumter, South |
| | NATURAL | Carolina, United States of |
| | | America) |
| M | Ultramid B33LN 01 | BASF Corporation |
| | | (Florham Park, New |
| | | Jersey, United States of |
| | | America) |
| N | Aegis H100MP | Honeywell International, |
| | | Inc. (Morristown, New |
| | | Jersey, United States of |
| | | America) |
| O | IP1070 | Ingenia Polymers |
| | | (Houston, Texas, United |
| | | States of America) |
| P | EXACT 3024 | ExxonMobile (Fairfax, |
| | | Virginia, United States of |
| | | America) |
| Q | Ultramid c40 L 01 | BASF Corporation |
| | | (Florham Park, New |
| | | Jersey, United States of |
| | | America) |
| R | Ultramid c40 01 | BASF Corporation |
| | | (Florham Park, New |
| | | Jersey, United States of |
| | | America) |
| S | ULTRAMID B40 | BASF Corporation |
| | | (Florham Park, New |
| | | Jersey, United States of |
| | | America) |
| T | VERSIFY DP 3000 | Dow Chemical Company |
| | | (Midland, Michigan, |
| | | United States of America) |
| U | M7672 | Total Petrochemicals |
| | | (Houston, Texas, United |
| | | States of America) |
| V | APPEEL 72D799 | E. I. du Pont de Nemours |
| | | and Company |
| | | (Wilmington, Delaware, |
| | | United States of America) |
| W | FSU 255E | A. Schulman, Inc. (Akron, |
| | | Ohio, United States of |
| | | America) |
| Y | BYNEL 39E660 | E. I. du Pont de Nemours |
| | | and Company |
| | | (Wilmington, Delaware, |
| | | United States of America) |
| Z | Escorene Ultra LD 721.IK | ExxonMobile (Fairfax, |
| | | Virginia, United States of |
| | | America) |
| AA | Pro-fax SR257M | Basell Polyolefins |
| | | (Wilmington, Delaware, |
| | | United States of America) |
| BB | 40604 | Ampacet (Tarrytown, |
| | | New York, United States |
| | | of America) |
| CC | Basell Pro-Fax PH835 | Basell Polyolefins |
| | | (Wilmington, Delaware, |
| | | United States of America) |
| DD | 503149 | Ampacet (Tarrytown, |
| | | New York, United States |
| | | of America) |
| EE | ID105.3 | ExxonMobile (Fairfax, |
| | | Virginia, United States of |
| | | America) |
| FF | Elite 5500GT | Dow Chemical Company |
| | | (Midland, Michigan, |
| | | United States of America) |
| GG | SP 2260 | Eastman Chemical |
| | | Company (Kingsport, |
| | | Tennessee, United |
| | | States of America) |
| HH | XUR1367 | Dow Chemical Company |
| | | (Midland, Michigan, |
| | | United States of America) |
| II | SARAN 806 | Dow Chemical Company |
| | | (Midland, Michigan, |
| | | United States of America) |

A is a compounded polymer blend consisting of Surlyn 1650, EMA (Dupont Elvaloy 1913AC), and polybutene.
B is a low density polyethylene (LDPE) homopolymer with density of 0.914-0.916 g/cc at 23° C. and DSC melting point of 104° C.
C is a polypropylene copolymer with 2.2 mole percent propylene and 80 mole percent ethylene, with density of 0.85-0.89 g/cc and DSC melting point of 41° C.
D is a linear low density polyethylene (LLDPE), with density of 0.916-0.920 g/cc and DSC melting point of 115° C.
E is a maleic anhydride-modified polyethylene with density of 0.919-0.925 g/cc, vicat softening point of 100° C., and melting point of 125° C.
F is an amorphous nylon copolymer (6I/6T) comprised of hexamethylene diamine, isophthalic acid, and terephthalic acid, with density of 1.16-1.20 g/cc and glass transition temperature (Tg) of 125° C.
G is a polyamide (nylon) with specific gravity of 1.135 and DSC melting point of 220° C.
H is a polyamide (nylon) with density of 1.13 g/cc.
I is an ethylene/vinyl alcohol copolymer with 36-40 mole percent ethylene, density of 1.16-1.18 g/cc, and DSC melting point of 173° C.
J is an ethylene/vinyl alcohol copolymer with 36.5-39.5 mole percent ethylene, density of 1.17 g/cc, and DSC melting point of 173° C.
K is a nylon-based antiblock and slip agent masterbatch comprised of about 70% polyamide (nylon 6), about 20% diatomaceous earth, and about 10% erucamide. K has a density of 1.17-1.23 g/cc at 23° C. and melting point of 216-224° C.
L is a nylon-based antiblock and slip agent masterbatch comprising 5% talcum (magnesium silicate), 5% calcium carbonate, and 5% N,N-ethylene bis stearmide, with specific gravity of 1.13-1.17 and DSC melting point of 220° C.
M is a polyamide (nylon) with melting point of 210-230° C. and specific gravity of 1.135-1.145.
N is a polyamide (nylon) with specific gravity of 1.135 and DSC melting point of 220° C.
O is antiblock and slip agent masterbatch containing 85.5% LLDPE carrier, 10% diatomaceous earth, and 4.5% erucamide. O has density of 0.97 g/cc.
P is a very low density polyethylene copolymer of ethylene and 1-butene produced by single site metallocene catalysis, with density of 0.904-0.906 g/cc.
Q is a lubricated polyamide (nylon) with density of 1.115-1.125 g/cc and DSC melting point of 190° C.
R is a polyamide (nylon) with density of 1.115-1.125 g/cc and DSC melting point of 190° C.
S is a polyamide (nylon) with specific gravity 1.125-1.135 and DSC melting point of 210-230° C.
T is a propylene/ethylene copolymer.
U is a propylene/ethylene copolymer with density of 0.895 g/cc and melting point 136-144° C.
V is a blend of 58% ionomer, 22% ethylene/vinyl acetate copolymer and 20% polybutylene, with density of 0.932 g/cc.
W is polyethylene-based antiblock and slip agent masterbatch containing 67.9% LDPE, 25% diatomaceous earth silica, 5% erucamide, and 0.1% stabilizer, with density of 1.08 g/cc and melting point 113° C.
Y is a maleic anhydride-modified ethylene/vinyl acetate copolymer with density of 0.943 g/cc, melting point of 95° C., and vicat softening point of 72° C.
Z is an ethylene/vinyl acetate copolymer (18.5% VA) with density of 0.942 g/cc.
AA is a polypropylene copolymer with approximately 700 PPM of Irganox 1010 and 750 PPM of Irgafos 168, or equivalent antioxidants.
BB is a polypropylene-based amide wax containing 5% erucamide, with specific gravity of 0.899 and heat stability of 600° F.
CC is a polypropylene homopolymer with melt flow rate of 34.0 g/10 min and density of 0.902 g/cc.
DD is antiblock and slip agent masterbatch.
EE is a low density polyethylene homopolymer.
FF is a linear low density polyethylene.
GG is an ethylene/methyl acrylate copolymer with 22-25% methyl acrylate content and density of 0.947 g/cc.
HH is a vinylidene chloride/methyl acrylate copolymer.
II is a vinylidene chloride/methyl acrylate copolymer comprising a blend of 100 phr (parts per hundred resin) VDC/MA copolymer, 2 phr expoxidized soybean oil, and 2 phr MMA/BMA/BA terpolymers, with DSC range of 141.5-146.5° C.

TABLE 2
Film Identification

| Film ID | Layer | Formulation | Volume % | Mils |
|---|---|---|---|---|
| Film 1 | 1 | 8% O | 0.40 | 8 |
| | | 92% P | | |
| | 2 | 100% V | 0.75 | 15 |
| | 3 | 100% E | 0.40 | 8 |
| | 4 | 30% Q | 0.65 | 13 |
| | | 70% S | | |
| | 5 | 100% J | 0.50 | 10 |
| | 6 | 30% Q | 0.65 | 13 |
| | | 70% S | | |
| | 7 | 100% E | 0.40 | 9 |
| | 8 | 100% T | 0.80 | 16 |
| | 9 | 100% U | 0.40 | 8 |
| Film 2 | 1 | 6% W | 0.38 | 15 |
| | | 94% P | | |
| | 2 | 10% B | 0.50 | 20 |
| | | 90% D | | |
| | 3 | 100% E | 0.20 | 8 |
| | 4 | 20% F | 0.16 | 65 |
| | | 80% H | | |
| | 5 | 100% J | 0.20 | 8 |
| | 6 | 20% F | 0.16 | 6.5 |
| | | 80% H | | |
| | 7 | 100% Y | 0.58 | 23 |
| | 8 | 2% L | 0.33 | 13 |
| | | 2% K | | |
| | | 96% M | | |
| Film 3 | 1 | 6% W | 0.48 | 12 |
| | | 94% P | | |
| | 2 | 10% B | 0.84 | 21 |
| | | 90% D | | |
| | 3 | 100% Z | 0.28 | 7 |
| | 4 | 100% AA | 0.52 | 13 |
| | 5 | 100% Z | 0.28 | 7 |
| | 6 | 100% AA | 0.52 | 13 |
| | 7 | 100% Z | 0.60 | 15 |
| | 8 | 2% BB | 0.48 | 12 |
| | | 98% CC | | |
| Film 4 | 1 | 6% W | 0.45 | 15 |
| | | 94% P | | |
| | 2 | 10% B | 0.60 | 20 |
| | | 90% D | | |
| | 3 | 100% E | 0.24 | 8 |
| | 4 | 20% F | 0.20 | 6.5 |
| | | 80% H | | |
| | 5 | 100% J | 0.24 | 8 |
| | 6 | 20% F | 0.20 | 6.5 |
| | | 80% H | | |
| | 7 | 100% Y | 0.69 | 23 |
| | 8 | 2% L | 0.39 | 13 |
| | | 2% K | | |
| | | 96% M | | |
| Film 5 | 1 | 4% O | 0.40 | 8 |
| | | 96% P | | |
| | 2 | 10% B | 0.85 | 17 |
| | | 90% D | | |
| | 3 | 100% E | 0.40 | 8 |
| | 4 | 30% Q | 0.65 | 13 |
| | | 70% S | | |
| | 5 | 100% J | 0.50 | 10 |
| | 6 | 30% Q | 0.65 | 13 |
| | | 70% S | | |
| | 7 | 100% E | 0.35 | 7 |
| | 8 | 100% T | 0.80 | 16 |
| | 9 | 100% U | 0.40 | 8 |
| Film 6 | 1 | 100% A | 8 | 0.28 |
| | 2 | 10% B | 19 | 0.67 |
| | | 35% C | | |
| | | 55% D | | |
| | 3 | 100% E | 8 | 0.28 |
| | 4 | 20% F | 9 | 0.32 |
| | | 80% G | | |
| | 5 | 100% I | 8 | 0.28 |
| | 6 | 20% F | 9 | 0.32 |
| | | 80% G | | |
| | 7 | 100% E | 31 | 1.09 |
| | 8 | 2% K | 8 | 0.28 |
| | | 2% L | | |
| | | 96% M | | |
| Film 7 | 1 | 4% O | 0.48 | 8 |
| | | 96% P | | |
| | 2 | 10% B | 1.02 | 17 |
| | | 90% D | | |
| | 3 | 100% E | 0.48 | 8 |
| | 4 | 30% Q | 0.78 | 13 |
| | | 70% S | | |
| | 5 | 100% J | 0.60 | 10 |
| | 6 | 30% Q | 0.78 | 13 |
| | | 70% S | | |
| | 7 | 100% E | 0.42 | 7 |
| | 8 | 100% T | 0.96 | 16 |
| | 9 | 100% U | 0.48 | 8 |
| Film 8 | 1 | 6% W | 0.53 | 15 |
| | | 94% P | | |
| | 2 | 10% B | 0.70 | 20 |
| | | 90% D | | |
| | 3 | 100% E | 0.28 | 8 |
| | 4 | 20% F | 0.23 | 65 |
| | | 80% H | | |
| | 5 | 100% J | 0.28 | 8 |
| | 6 | 20% F | 0.23 | 6.5 |
| | | 80% H | | |
| | 7 | 100% Y | 0.81 | 23 |
| | 8 | 2% L | 0.46 | 13 |
| | | 2% K | | |
| | | 96% M | | |
| Film 9 | 1 | 5% DD | 1.04 | 34.7 |
| | | 20% EE | | |
| | | 75% FF | | |
| | 2 | 100% GG | 0.16 | 5.3 |
| | 3 | 90% HH | 0.60 | 20 |
| | | 10% II | | |
| | 4 | 100% GG | 0.16 | 5.3 |
| | 5 | 5% DD | 1.04 | 34.7 |
| | | 20% EE | | |
| | | 75% FF | | |

### Example 1

### Manufacture of Marinade Package 1

Forming Film 1, with the composition and construction shown in Table 2, was formed by coextrusion of layers. Film 1 was loaded onto a Multivac Model 230 packaging machine (available from Multivac, Wolfertschwenden, Germany) with the sealant layer side facing upwards as conveyed. The film was then heated and thermoformed with the assistance of a vacuum into a two-compartment support member with a relatively large compartment (the food product compartment) and a relatively small compartment (the marinade compartment). Two pork loins were loaded into the large compartment and approximately six fluid ounces of a frozen KC Masterpiece® Honey Teriyaki marinade (available from the HV Food Products Company, Oakland, Calif., United States of America) were loaded into the smaller compartment. The marinade had been previously poured into molds and placed overnight in a freezer set at −17° F. to harden for easy loading and resistance to seal contamination.

Lidding Film 2, with the composition and construction shown in Table 2, was formed by coextrusion of layers and loaded onto the Multivac Model 230 machine. The machine was then indexed forward to convey the loaded support member to the vacuum packaging station of the Multivac 230. At this station, Film 2 was brought into contact with Film 1. Vacuum was applied to remove ambient air from the two compartments and heat was applied to hermetically heat seal Films 1 and 2 together along the perimeter and rupturable heat seal positions.

After removing the package from the machine, the package was judged to be hermetically vacuum sealed. The package was transferred to a refrigerated display case and stored overnight.

### Example 2

### Perimeter and Rupturable Seal Testing of Marinade Package 1

After storage, the package of Example 1 was removed from the refrigerated case, inverted, and placed onto a table, with the lidding film resting on the table surface. It was noted that the marinade had thawed to a fluid. Finger and thumb pressure was applied to the marinade compartment. The interior rupturable seal ruptured and marinade fluid was transferred to the pork loins.

The package was returned to refrigeration where the marinade was permitted to contact the meat surface for a period of hours. The package was subsequently opened by lifting the lidding film at a corner tab to peel the lidding from the compartment containing the pork. The marinated pork was removed from the package, the package discarded, and the pork cooked. After cooking, the pork had excellent flavor and texture.

### Example 3

### Manufacture of Marinade Package 2

Forming Film 3, with the composition and construction shown in Table 2, was formed by coextrusion of layers. Film 3 was loaded onto a Multivac Model 230 packaging machine, with the sealant layer side facing upward as conveyed. The film was then heated and thermoformed with the assistance of a vacuum into a 2-compartment support member having a relatively large compartment (the food product compartment) and a comparably smaller compartment (the marinade compartment). Three chicken breasts were loaded into the large compartment and approximately 6 fluid ounces of a frozen Lawry's® Caribbean Jerk marinade was loaded into the smaller compartment. The marinade had been previously poured into molds and placed overnight in a freezer set at −17° F. to freeze for easy loading and resistance to seal contamination.

Lidding film 4, with the composition and construction shown in Table 2, was formed by coextrusion of layers. Film 4 was also loaded onto the Multivac Model 230 machine. The machine was then indexed forward to convey the loaded support member to the vacuum packaging station of the Multivac 230. At this station, Film 4 was brought into contact with Film 3. Vacuum was applied to remove ambient air for the two compartments and heat was applied to hermetically heat seal Films 3 and 4 together along the perimeter and interior heat seal positions.

After removing the package from the machine, the package was judged to be hermetically vacuum sealed. The package was transferred to a refrigerated display case and stored overnight.

### Example 4

### Perimeter and Rupturable Seal Testing of Marinade Package 2

After refrigerating the package overnight, the package was removed from the refrigerated case, inverted, and placed on a table with the lidding film resting on the table surface. It was noted that the marinade had thawed to a fluid at this time. Finger and thumb pressure was applied to the marinade compartment, rupturing the interior rupturable seal and transferring the marinade fluid to the chicken breasts without rupturing the perimeter heat seals.

### Example 5

### Manufacture of Marinade Package 3

Forming Film 5, with the composition and construction shown in Table 2, was formed by coextrusion of layers. Film 5 was loaded onto a Multivac Model 230 packaging machine, with the sealant layer side facing upward as conveyed. The film was then heated and thermoformed with the assistance of a vacuum into a 2-compartment support member having a relatively large compartment and a comparably smaller compartment.

Lidding film 6, with the composition and construction shown in Table 2, was formed by coextrusion of layers. Film 6 was also loaded onto the Multivac Model 230 machine. The machine was then indexed forward to convey the loaded support member to the vacuum packaging station of the Multivac 230. At this station, Film 6 was brought into contact with Film 5. Vacuum was applied to remove ambient air for the two compartments and heat was applied to hermetically heat seal Films 5 and 6 together along the perimeter and interior heat seal positions. Temperature settings of 120° C., 130° C., and 140° C. were used to make three replicates of Package 3. A pocket was not drawn on the packages used for the Instron test, making them easier to cut and pull straight.

Seal Strength testing, also known as Peel Testing, was performed as set forth below (using Instron and Mocon testing methods). Seal strength testing measures the strength of seals within flexible barrier materials and can be used to determine consistency within the seal, as well as to evaluate the opening force of the package system. Seal strength is a quantitative measure for use in process validation, process control and capability. Seal strength is not only relevant to opening force, and package integrity, but to measuring the packaging processes' ability to produce consistent seals.

### Example 6

### Instron Seal Strength Testing of Marinade Package 3

On the Instron using the standard “seal strength 32” test method, several seals around the package were tested. In the Instron tests performed, an inch-wide cut was taken perpendicular to the particular seal tested, leaving a flap attached to the top and bottom material sealed together. Each flap was inserted into a jaw on the Instron test unit and a pull cycle started. The resulting seal strengths were compared to Maximum Force, measured in pounds of force “lbf”.

The backside is located at the end of the package on the marinade side next to the end user when squeezing the package to rupture the rupturable seal and distribute the marinade to the product side. The backside seal was tested as sealed in the Multivac machine and with an additional secondary Vertrod seal applied to the package to determine if the seal would be strengthened in this area.

An impinged seal was also tested in two areas. The impinged seal is located at an area in the shape of a chevron or “v” that was built into the Multivac tooling for the package. The seal dividing the two sides of the package (marinade side from the product side) runs in a straight line and dips in the center of the package with the point of the V on the marinade side. A direct pull was applied to the point of the chevron and through the seal area from the marinade side to the product side of the package. Samples were also taken on the side of the V of the chevron.

20 samples of each package were tested and the results are shown in the Tables below.

Tables 3, 4, 5, 6, and 7 set forth the data from the Instron testing of the backside seal, impinged side seal, impinged seal point, side seal, and backside seal with secondary seal, respectively.

TABLE 3
Package 3 Instron Testing of Backside Seal

| | | | |
|---|---|---|---|
| Seal Temp. | 120 | 130 | 140 |
| (° C.) | | | |
| Backside | A1 | A2 | A3 |
| seal | | | |
| Average | 1.613 | 2.008 | 2.082 |
| (lbf) | | | |
| Std. | 0.155 | 0.253 | 0.154 |
| Deviation | | | |
| Maximum | 2.134 | 2.380 | 2.342 |
| Minimum | 1.399 | 1.423 | 1.798 |

TABLE 4
Package 3 Instron Testing of Impinged Side Seal

| | |
|---|---|
| Seal Temp. | 120 |
| (° C.) | |
| Impinged | B1 |
| seal side | |
| Average | 1.420 |
| (lbf) | |
| Std. | 0.072 |
| Deviation | |
| Maximum | 1.620 |
| Minimum | 1.316 |

TABLE 5
Package 3 Instron Testing of Impinged Seal Point

| | | | |
|---|---|---|---|
| Seal Temp. | 120 | 130 | 140 |
| (° C.) | | | |
| Impinged | K1 | K2 | K3 |
| seal Point | | | |
| Average | 0.741 | 0.934 | 1.060 |
| (lbf) | | | |
| Std. | 0.113 | 0.112 | 0.118 |
| Deviation | | | |
| Maximum | 0.953 | 1.128 | 1.259 |
| Minimum | 0.570 | 0.732 | 0.823 |

TABLE 6
Package 3 Instron Testing of Side Seal

| | | | |
|---|---|---|---|
| Seal Temp. | 120 | 130 | 140 |
| (° C.) | | | |
| Side seal | C1 | C2 | C3 |
| Average | 1.504 | 1.993 | 2.172 |
| (lbf) | | | |
| Std. | 0.133 | 0.430 | 0.366 |
| Deviation | | | |
| Maximum | 1.714 | 2.991 | 3.015 |
| Minimum | 1.178 | 1.466 | 1.794 |

TABLE 7
Package 3 Instron Testing of Backside Seal with Secondary Seal

| | | | |
|---|---|---|---|
| Seal Temp. | 120 | 130 | 140 |
| (° C.) | | | |
| Backside | D1 | D2 | D3 |
| seal with | | | |
| secondary | | | |
| Average | 1.770 | 2.256 | 2.384 |
| (lbf) | | | |
| Std. | 0.272 | 0.359 | 0.192 |
| Deviation | | | |
| Maximum | 2.403 | 3.014 | 2.750 |
| Minimum | 1.416 | 1.608 | 2.056 |

### Example 7

### Mocon Burst Seal Strength Testing of Marinade Package 3

A Mocon burst test was carried out by inflating a series of pouches under standard conditions and measuring the average pressure required to burst the pouch on a MOCON SKYE 2000™ machine, sold by Modern Controls, Inc. (Minneapolis, Minn., United States of America). To carry out the burst test, test packages sealed on all four sides were provided. A sealing septum was adhered to a dry, smooth location on the package being tested. An inflation needle was inserted into the package through the hole in the sealing septum. The package is installed in the package fixture. Once the test was started, the package inflated. When the package ruptured, the system shut off the air supply and terminated the test. The air pressure at which the package burst was calculated and reported as the result.

Both compartments of Package 3 were tested to determine the highest probability of seal failure for each seal tested. Each package was visually inspected after the burst for seal integrity of each seal within the compartments. In each case, the seal locations were based off the seal that has the chevron, with the back seal being the seal opposite, and the side seal being the seal on either side. A vacuum was not drawn on the Mocon packages, making them easier to put the needle in the pocket.

Results of the Mocon burst seal strength test for the smaller compartment (the marinade compartment) and the larger compartment (the product compartment) are given in Tables 8 and 9, respectively, below.

TABLE 8
Package 3 Marinade Compartment Mocon Test Results

| | | | |
|---|---|---|---|
| Seal Temp (° C.) | 120 | 130 | 140 |
| Marinade Pocket | E1 | E2 | E3 |
| Avg. (psi) | 1.418 | 1.543 | 1.659 |
| Std. Deviation | 0.253 | 0.195 | 0.217 |
| Maximum | 1.837 | 1.954 | 1.968 |
| Minimum | 0.9 | 1.2 | 1.1 |
| Chevron^{a} | 19 | 19 | 19 |
| Chevron^{b} | 0 | 0 | 0 |
| Side^{a} | 0 | 0 | 0 |
| Side^{b} | 0 | 0 | 0 |
| Back^{a} | 0 | 0 | 0 |
| Back^{b} | 0 | 0 | 0 |

*^{a}is the number of total failures in the seal area.
*^{b}is the number of seals that lost seal integrity but did not completely fail.

TABLE 9
Package 3 Product Compartment Mocon Test Results

| | | | |
|---|---|---|---|
| Seal Temp (° C.) | 120 | 130 | 140 |
| Product Pocket | H1 | H2 | H3 |
| Avg. (psi) | 1.245 | 1.340 | 1.389 |
| Std. Deviation | 0.054 | 0.071 | 0.106 |
| Maximum | 1.341 | 1.458 | 1.604 |
| Minimum | 1.123 | 1.210 | 1.225 |
| Chevron^{a} | 14 | 16 | 17 |
| Chevron^{b} | 1 | 0 | 0 |
| Side^{a} | 4 | 3 | 2 |
| Side^{b} | 15 | 16 | 5 |
| Back^{a} | 1 | 0 | 0 |
| Back^{b} | 1 | 0 | 0 |

*^{a}is the number of total failures in the seal area.
*^{b}is the number of seals that lost seal integrity but did not completely fail.

### Example 8

### Manufacture of Marinade Package 4

Forming Film 7, with the composition and construction shown in Table 2, was formed using the same method as the forming film set forth in Example 5. Lidding film 6, with the composition and construction shown in Table 2, was formed using the same method as the lidding film of Example 5.

### Example 9

### Instron Seal Strength Testing of Marinade Package 4

On the Instron using the standard “seal strength 32” test method as set forth in Example 6 above, the impinged side seal of Package 4 was tested. The data was compiled in Table 10 below.

TABLE 10
Package 4 Instron Testing of Impinged Side Seal

Film 1/Film 3

| | | |
|---|---|---|
| Seal Temp. | 130 | 140 |
| (° C.) | | |
| Impinged | M2 | M3 |
| side seal | | |
| Average | 1.56 | 1.692 |
| (lbf) | | |
| Std. | 0.164 | 0.188 |
| Deviation | | |
| Maximum | 2.16 | 2.048 |
| Minimum | 1.380 | 1.444 |

### Example 10

### Drop Testing of Package 4

Drop testing is used to determine the ability of a package to retain and protect its contents after a free fall. The method can duplicate the rigors associated with manual or mechanical handling at loading and unloading points. Using accelerometers and computer-aided testing software, the acceleration levels experienced anywhere on the package can be measured. The testing allows users to determine whether package cushioning is desirable. However, one of ordinary skill in the art would understand that drop tests use only one variable, and that box design, secondary packaging (such as inclusion of cardboard or bubble wrap), product placement (such as aligning the packages marinade-to-marinade or marinade-to-food product compartments), and number of packages all play a role in the test results.

Chicken was packaged in Package 4 and drop tests were performed on six boxes containing six 2-pound chickens and 8 ounces of marinade. The boxes were drop tested from a height of 36 inches. A U-shaped piece of cardboard was placed over the bottom layer, and a slip sheet was placed between the top and middle layer. Results are indicated in Table 11.

Chicken was packaged in Package 4 and drop tests were performed on 4 boxes containing six 2-pound chicken and 8 ounces of marinade packages per box. The drops were tested from a height of 36 inches. A U-shaped piece of cardboard was placed over the bottom layer. The meat and marinade pockets were stacked in the same position in each layer. Results are given in Table 12.

Chicken was packaged in Package 4 and drop tests were performed on 3 boxes containing six 2-pound chicken and 8 ounces of marinade packages per box with bubble wrap between the marinade pocket on each layer. The drops were tested from a height of 36 inches. The drop was the second drop for those packages that were intact after the first drop from Table 12. Results are given in Table 13.

Beef was packaged in Package 4 and drop tests were performed on eight boxes containing six packages of 2-pound sirloin steaks and 8 ounces of marinade per box. The boxes were drop tested from a height of 36 inches. A U-shaped piece of cardboard was placed over the bottom layer, and a slip sheet was placed between the top and middle layer. The packages were placed in an alternate pattern of marinade and beef as they were placed in the box. Results are indicated in Table 14.

Beef was packaged in Package 4 and drop tests were performed on four boxes containing six packages of 2-pound sirloin steaks and 8 ounces of marinade per box. The boxes were drop tested from a height of 36 inches. A U-shaped piece of cardboard was placed over the bottom layer. The meat and marinade pockets were stacked in the same position in each layer. Results are indicated in Table 15.

Beef was packaged in Package 4 and drop tests were performed on two boxes containing six packages of 2-pound sirloin steaks and 8 ounces of marinade per box. The boxes were drop tested from a height of 36 inches. Bubble wrap was placed between the marinade pockets on each layer. The meat and marinade pockets were stacked in the same position in each layer. The drop was the second drop for those packages that were intact after the first drop from Table 15. Results are indicated in Table 16.

TABLE 11
Drop Test Results Package 4

| | Bottom Layer | | | Middle Layer | | | Top Layer | | |
|---|---|---|---|---|---|---|---|---|---|
| Box | No | Partial | | No | Partial | | No | Partial | |
| No. | Failure | Failure | Failure | Failure | Failure | Failure | Failure | Failure | Failure |
| 1 | 0 | 1 | 1 | 1 | 0 | 1 | 1 | 0 | 1 |
| 2 | 1 | 0 | 1 | 0 | 0 | 2 | 1 | 1 | 0 |
| 3 | 0 | 0 | 2 | 0 | 0 | 2 | 2 | 0 | 0 |
| 4 | 0 | 0 | 2 | 0 | 1 | 1 | 2 | 0 | 0 |
| 5 | 0 | 2 | 0 | 0 | 2 | 0 | 2 | 0 | 0 |
| 6 | 1 | 1 | 0 | 0 | 2 | 0 | 2 | 0 | 0 |
| Total | 2 | 4 | 6 | 1 | 5 | 6 | 10 | 1 | 1 |

| | | | |
|---|---|---|---|
| Total | 13 | 10 | 13 |
| all | | | |
| layers | | | |
| % all | 36 | 28 | 36 |
| layers | | | |

TABLE 12
Drop Testing Results 2 Package 4

| | No Failure | Partial Failure | Failure |
|---|---|---|---|
| Total | 21 | 3 | 0 |
| all | | | |
| layers | | | |
| % all | 88 | 8 | 0 |
| layers | | | |

TABLE 13
Drop Testing Results 3 Package 4

| | No Failure | Partial Failure | Failure |
|---|---|---|---|
| Total | 8 | 8 | 2 |
| all | | | |
| layers | | | |
| % all | 44 | 44 | 12 |
| layers | | | |

TABLE 14
Drop Testing Results 4 Package 4

| | Bottom Layer | | | Middle Layer | | | Top Layer | | |
|---|---|---|---|---|---|---|---|---|---|
| Box | No | Partial | | No | Partial | | No | Partial | |
| No. | Failure | Failure | Failure | Failure | Failure | Failure | Failure | Failure | Failure |
| 1 | 1 | 1 | 0 | 1 | 1 | 0 | 2 | 0 | 0 |
| 2 | 1 | 1 | 0 | 1 | 1 | 0 | 2 | 0 | 0 |
| 3 | 1 | 1 | 0 | 0 | 2 | 0 | 2 | 0 | 0 |
| 4 | 0 | 2 | 0 | 2 | 0 | 0 | 2 | 0 | 0 |
| 5 | 2 | 0 | 0 | 1 | 1 | 0 | 2 | 0 | 0 |
| 6 | 2 | 0 | 0 | 0 | 1 | 1 | 1 | 1 | 0 |
| 7 | 2 | 0 | 0 | 0 | 1 | 1 | 1 | 1 | 0 |
| 8 | 0 | 2 | 0 | 0 | 1 | 1 | 1 | 1 | 0 |
| Total | 9 | 7 | 0 | 5 | 8 | 3 | 14 | 2 | 0 |

| | | | |
|---|---|---|---|
| Total | 28 | 17 | 3 |
| all | | | |
| layers | | | |
| % all | 58 | 35 | 7 |
| layers | | | |

TABLE 15
Drop Testing Results 5 Package 4

| | No Failure | Partial Failure | Failure |
|---|---|---|---|
| Total | 18 | 5 | 1 |
| all | | | |
| layers | | | |
| % all | 75 | 21 | 4 |
| layers | | | |

TABLE 16
Drop Testing Results 6 Package 4

| | No Failure | Partial Failure | Failure |
|---|---|---|---|
| Total | 5 | 6 | 1 |
| all | | | |
| layers | | | |
| % all | 42 | 50 | 8 |
| layers | | | |

### Example 11

### Manufacture of Marinade Package 5

Forming Film 1, with the composition and construction shown in Table 2, was formed using the method for the forming film of Example 5. Lidding film 8, with the composition and construction shown in Table 2, was formed using the method for the lidding film of Example 5.

### Example 12

### Instron Seal Strength Testing of Marinade Package 5

On the Instron using the standard “seal strength 32” test method (as in Example 6 above), the backside, impinged side, impinged seal point, side, and backside seal with secondary seals of Package 5 were tested as set forth in Tables 17-21 below.

TABLE 17
Package 5 Instron Testing of Backside Seal

| | | | |
|---|---|---|---|
| Seal Temp. | 120 | 130 | 140 |
| (° C.) | | | |
| Backside | A4 | A5 | A6 |
| seal | | | |
| Average | 2.127 | 7.838 | 1.969 |
| (lbf) | | | |
| Std. | 0.328 | 0.251 | 0.237 |
| Deviation | | | |
| Maximum | 3.236 | 2.665 | 2.552 |
| Minimum | 1.381 | 1.442 | 1.482 |

TABLE 18
Package 5 Instron Testing of Impinged Side Seal

| | | | |
|---|---|---|---|
| Seal Temp. | 120 | 130 | 140 |
| (° C.) | | | |
| Impinged | B4 | B5 | B6 |
| seal side | | | |
| Average | 1.480 | 1.472 | 1.884 |
| (lbf) | | | |
| Std. | 0.172 | 0.212 | 2.940 |
| Deviation | | | |
| Maximum | 1.816 | 2.224 | 2.940 |
| Minimum | 1.3 | 1.28 | 1.340 |

TABLE 19
Package 5 Instron Testing of Impinged Seal Point

| | | | |
|---|---|---|---|
| Seal Temp. | 120 | 130 | 140 |
| (° C.) | | | |
| Impinged | K4 | K5 | K6 |
| seal Point | | | |
| Average | 1.207 | 1.402 | 1.420 |
| (lbf) | | | |
| Std. | 0.085 | 0.076 | 0088 |
| Deviation | | | |
| Maximum | 1.315 | 1.548 | 1.624 |
| Minimum | 1.085 | 1.274 | 1.271 |

TABLE 20
Package 5 Instron Testing of Side Seal

| | | | |
|---|---|---|---|
| Seal Temp. | 120 | 130 | 140 |
| (° C.) | | | |
| Side seal | C4 | C5 | C6 |
| Average | 2.709 | 2.229 | 2.315 |
| (lbf) | | | |
| Std. | 0.834 | 0.357 | 0.240 |
| Deviation | | | |
| Maximum | 4.001 | 3.306 | 2.905 |
| Minimum | 1.602 | 1.848 | 1.953 |

TABLE 21
Package 5 Instron Testing of Backside Seal with Secondary Seal

| | | | |
|---|---|---|---|
| Seal Temp. | 120 | 130 | 140 |
| (° C.) | | | |
| Backside | D4 | D5 | D6 |
| seal with | | | |
| secondary | | | |
| Average | 2.364 | 2.040 | 2.003 |
| (lbf) | | | |
| Std. | 0.306 | 0.276 | 0.296 |
| Deviation | | | |
| Maximum | 3.182 | 2.545 | 2.754 |
| Minimum | 1.991 | 1.581 | 1.452 |

### Example 13

### Mocon Burst Seal Strength Testing of Marinade Package 5

Both compartments of Package 5 were tested to determine the highest probability of seal failure for each using the Mocon burst seal strength test, as described in Example 7.

Results of the Mocon burst seal strength test for the smaller marinade compartment and the larger product compartment are given in Tables 22 and 23, respectively, below.

TABLE 22
Package 5 Marinade Compartment Mocon Testing Results

| | | | |
|---|---|---|---|
| Seal Temp. | 120 | 130 | 140 |
| (° C.) | | | |
| Marinade | E4 | E5 | E6 |
| Pocket | | | |
| Avg. (psi) | 2.187 | 2.175 | 2.281 |
| Std. | 0.143 | 0.199 | 0.168 |
| Deviation | | | |
| Maximum | 2.406 | 2.551 | 2.508 |
| Minimum | 1.939 | 1.881 | 1.939 |
| Chevron^{a} | 0 | 0 | 8 |
| Chevron^{b} | 0 | 0 | 2 |
| Side^{a} | 0 | 0 | 0 |
| Side^{b} | 0 | 0 | 0 |
| Back^{a} | 19 | 19 | 11 |
| Back^{b} | 0 | 0 | 0 |

^{a}is the number of total failures in the seal area.
^{b}is the number of seals that lost seal integrity but did not completely fail.

TABLE 23
Package 5 Product Compartment Mocon Test Results

| | | | |
|---|---|---|---|
| Seal Temp. | 120 | 130 | 140 |
| (° C.) | | | |
| Product | H4 | H5 | H6 |
| Pocket | | | |
| Avg. (psi) | 1.393 | 1.433 | 1.555 |
| Std. | 0.107 | 0.121 | 0.096 |
| Deviation | | | |
| Maximum | 1.691 | 1.645 | 1.793 |
| Minimum | 1.239 | 1.108 | 1.429 |
| Chevron^{a} | 16 | 19 | 19 |
| Chevron^{b} | 0 | 0 | 0 |
| Side^{a} | 3 | 0 | 0 |
| Side^{b} | 0 | 0 | 0 |
| Back^{a} | 0 | 0 | 0 |
| Back^{b} | 0 | 0 | 0 |

^{a}is the number of total failures in the seal area.
^{b}is the number of seals that lost seal integrity but did not completely fail.

### Example 14

### Manufacture of Marinade Package 6

Forming Film 5, with the composition and construction shown in Table 2, was formed using the method for the forming film of Example 5. Lidding film 9 is a thermoplastic laminate film with the composition and construction shown in Table 2.

### Example 15

### Instron Seal Strength Testing of Marinade Package 6

On the Instron using the standard “seal strength 32” test method as in Example 6 above, backside, impinged seal point, side, and backside seal with secondary seals were tested. The data is compiled in Tables 24-27 below.

TABLE 24
Instron Testing of Package 6 Backside Seal

| | | | |
|---|---|---|---|
| Seal Temp. | 120 | 130 | 140 |
| (° C.) | | | |
| Backside | A7 | A8 | A9 |
| seal | | | |
| Average | 1.945 | 2.297 | 2.419 |
| (lbf) | | | |
| Std. | 0.305 | 0.198 | 0.366 |
| Deviation | | | |
| Maximum | 2.561 | 2.855 | 3.258 |
| Minimum | 1.426 | 2.074 | 1.907 |

TABLE 25
Instron Testing of Package 6 Impinged Seal Point

| | | | |
|---|---|---|---|
| Seal Temp. | 120 | 130 | 140 |
| (° C.) | | | |
| Impinged | K7 | K8 | K9 |
| seal Point | | | |
| Average | 1.069 | 1.339 | 1.574 |
| (lbf) | | | |
| Std. | 0.130 | 0.091 | 0.132 |
| Deviation | | | |
| Maximum | 1.363 | 1.581 | 1.784 |
| Minimum | 0.806 | 1.144 | 1.212 |

TABLE 26
Instron Testing of Package 6 Side Seal

| | | | |
|---|---|---|---|
| Seal Temp. | 120 | 130 | 140 |
| (° C.) | | | |
| Side seal | C7 | C8 | C9 |
| Average | 2.102 | 2.335 | 2.539 |
| (lbf) | | | |
| Std. | 0.169 | 0.132 | 0.385 |
| Deviation | | | |
| Maximum | 2.452 | 2.651 | 3.226 |
| Minimum | 1.840 | 2.086 | 2.080 |

TABLE 27
Instron Testing of Package 6 Backside Seal with Secondary Seal

| | | | |
|---|---|---|---|
| Seal Temp. | 120 | 130 | 140 |
| (° C.) | | | |
| Backside | D7 | D8 | D9 |
| seal with | | | |
| secondary | | | |
| Average | 2.180 | 2.879 | 2.629 |
| (lbf) | | | |
| Std. | 0.310 | 0.338 | 0.244 |
| Deviation | | | |
| Maximum | 2.936 | 3.626 | 3.180 |
| Minimum | 1.748 | 2.111 | 2.048 |

### Example 16

### Mocon Burst Seal Strength Testing of Marinade Package 6

Both compartments of Package 6 were tested to determine the highest probability of seal failure for each using the Mocon burst seal strength test, as described in Example 7.

Results of the Mocon burst seal strength test for the marinade and product compartments are given in Tables 28 and 29, respectively, below.

TABLE 28
Mocon Testing of Package 6 Marinade Compartment

| | | | |
|---|---|---|---|
| Seal Temp | 120 | 130 | 140 |
| (° C.) | | | |
| Marinade | E7 | E8 | E9 |
| Pocket | | | |
| Avg. (psi) | 1.730 | 1.627 | 1.720 |
| Std. | 0.283 | 0.158 | 0.345 |
| Deviation | | | |
| Maximum | 2.274 | 1.925 | 2.551 |
| Minimum | 1.268 | 1.385 | 1.137 |
| Chevron^{a} | 14 | 18 | 19 |
| Chevron^{b} | 0 | 0 | 0 |
| Side^{a} | 0 | 0 | 0 |
| Side^{b} | 0 | 0 | 0 |
| Back^{a} | 3 | 0 | 0 |
| Back^{b} | 1 | 0 | 0 |

^{a}is the number of total failures in the seal area.
^{b}is the number of seals that lost seal integrity but did not completely fail.

TABLE 29
Mocon Testing of Package 6 Product Compartment

| | | | |
|---|---|---|---|
| Seal Temp | 120 | 130 | 140 |
| (° C.) | | | |
| Product | H7 | H8 | H9 |
| Pocket | | | |
| Avg. (psi) | 1.204 | 1.177 | 1.263 |
| Std. | 0.099 | 0.148 | 0.131 |
| Deviation | | | |
| Maximum | 1.414 | 1.487 | 1.545 |
| Minimum | 1.006 | 1.000 | 1.000 |
| Chevron^{a} | 19 | 14 | 15 |
| Chevron^{b} | 0 | 0 | 0 |
| Side^{a} | 0 | 5 | 4 |
| Side^{b} | 0 | 3 | 3 |
| Back^{a} | 0 | 0 | 0 |
| Back^{b} | 0 | 0 | 0 |

^{a}is the number of total failures in the seal area.
^{b}is the number of seals that lost seal integrity but did not completely fail.

### Example 17

### Manufacture of Marinade Package 7

Forming Film 7, with the composition and construction shown in Table 2, was formed using the method for the forming film of Example 5. Lidding film 9 is a thermoplastic laminate film with the composition and construction shown in Table 2.

### Example 18

### Instron Seal Strength Testing of Marinade Package 7

On the Instron using the standard “seal strength 32” test method as in Example 6 above, the impinged side seal of Package 7 was tested. The data is compiled in Table 30 below.

TABLE 30
Instron Testing of Package 7 Impinged Side Seal

| | | | |
|---|---|---|---|
| Seal Temp. | 120 | 130 | 140 |
| (° C.) | | | |
| Impinged | M7 | M8 | M9 |
| side seal | | | |
| Average | 2.14 | 2.476 | 2.724 |
| (lbf) | | | |
| Std. | 0.312 | 0.260 | 0.408 |
| Deviation | | | |
| Maximum | 2.844 | 2.956 | 3.268 |
| Minimum | 1.704 | 1.952 | 1.776 |

### Example 19

### Drop Testing Results for Package 7

Chicken was packaged in Package 7 and drop tests were performed on six boxes containing six 2-pound chicken and 8 ounces of marinade. The boxes were drop tested from a height of 36 inches. A U-shaped piece of cardboard was placed over the bottom layer, and a slip sheet was placed between the top and middle layer. Meat and marinade were in alternate positions layer to layer. Results are indicated in Table 31.

Beef was packaged in Package 7 and drop tests were performed on eight boxes containing six 2-pound sirloin steaks and 8 ounces of marinade. The drops were drop tested from a height of 36 inches. A U-shaped piece of cardboard was placed over the bottom layer, and a slip sheet was placed between the top and middle layer. Meat and marinade were in alternate positions layer to layer. Results are indicated in Table 32.

TABLE 31
Drop Test Results Package 7

| | Bottom Layer | | | Middle Layer | | | Top Layer | | |
|---|---|---|---|---|---|---|---|---|---|
| Box | No | Partial | | No | Partial | | No | Partial | |
| No. | Failure | Failure | Failure | Failure | Failure | Failure | Failure | Failure | Failure |
| 1 | 0 | 2 | 0 | 0 | 2 | 0 | 0 | 1 | 1 |
| 2 | 0 | 2 | 0 | 0 | 0 | 2 | 1 | 1 | 0 |
| 3 | 0 | 1 | 1 | 0 | 1 | 1 | 2 | 0 | 0 |
| 4 | 0 | 1 | 1 | 0 | 1 | 1 | 2 | 0 | 0 |
| 5 | 0 | 1 | 1 | 0 | 1 | 1 | 1 | 1 | 0 |
| 6 | 0 | 2 | 0 | 0 | 1 | 1 | 2 | 0 | 0 |
| Total | 0 | 10 | 2 | 1 | 5 | 6 | 8 | 3 | 1 |

| | | | |
|---|---|---|---|
| Total | 9 | 18 | 9 |
| all | | | |
| layers | | | |
| % all | 25 | 50 | 25 |
| layers | | | |

TABLE 32
Drop Testing Results 2 Package 7

| | Bottom Layer | | | Middle Layer | | | Top Layer | | |
|---|---|---|---|---|---|---|---|---|---|
| Box | No | Partial | | No | Partial | | No | Partial | |
| No. | Failure | Failure | Failure | Failure | Failure | Failure | Failure | Failure | Failure |
| 1 | 0 | 1 | 1 | 0 | 1 | 1 | 0 | 0 | 0 |
| 2 | 0 | 1 | 1 | 0 | 1 | 1 | 2 | 0 | 0 |
| 3 | 1 | 1 | 0 | 0 | 0 | 2 | 1 | 1 | 0 |
| 4 | 1 | 1 | 0 | 0 | 0 | 2 | 2 | 0 | 0 |
| 5 | 1 | 1 | 0 | 1 | 1 | 0 | 2 | 0 | 0 |
| 6 | 0 | 1 | 1 | 0 | 1 | 1 | 1 | 1 | 0 |
| 7 | 0 | 1 | 1 | 0 | 1 | 1 | 2 | 0 | 0 |
| 8 | 1 | 1 | 0 | 0 | 1 | 1 | 2 | 0 | 0 |
| Total | 4 | 8 | 4 | 1 | 6 | 9 | 14 | 2 | 0 |

| | | | |
|---|---|---|---|
| Total | 19 | 16 | 13 |
| all | | | |
| layers | | | |
| % all | 40 | 33 | 33 |
| layers | | | |

What is claimed is:

1. A package for marinating a food item, said package comprising:
a. a first thermoformed film formed into a compartmented support member having at least two compartments, wherein a first compartment is adapted to contain a frozen food additive and a second compartment is adapted to contain a food product;
b. a second film peripherally sealed about the perimeter of the package to said first film forming a hermetically sealed container having a perimeter seal; and
c. a rupturable seal positioned between said at least two compartments, said seal being rupturable due to manual squeezing of one of the compartments, so as to allow the food additive to mix with the food product;
wherein said rupturable seal has a lower rupture pressure compared to said perimeter seal, and wherein said food item can be marinated directly in said package.

2. The package of claim 1, further comprising a secondary seal about the perimeter of the package adjacent to at least one of the two compartments.

3. The package of claim 1, further comprising an opening means.

4. The package of claim 3, wherein the opening means is selected from the group consisting of: a tear notch disposed at an edge of the package, a pull tab disposed at a corner of the package, a tear strip that extends laterally across the package, a plastic reclosable fastener that extends laterally across the package, and combinations thereof.

5. The package of claim 1, wherein the food additive is selected from the group comprising: marinade, proteolytic enzyme, bactericide, fungicide, preservative, wetting agent, antioxidant, viscosity control agent, brine, curing agent, flavoring agent, or combinations thereof.

6. The package of claim 1, wherein the food product is selected from the group comprising: meat, vegetable, or combinations thereof.

7. The package of claim 1, wherein said rupturable seal comprises one or more stress risers.

8. The package of claim 1, wherein the distance between said rupturable seal and an end of said package is about ¼ to ⅓ the length of the package.

9. A method of controlling the level of food additive imparted to a food product, the method comprising:
a. forming a first thermoformable thermoplastic film into a compartmented support member having at least two compartments wherein a first compartment is adapted to contain a food additive and a second compartment is adapted to contain a food product;
b. loading the compartmented support member with a charge of frozen food additive into a first compartment and a charge of a food product into a second compartment;
c. applying vacuum to the first and second charged compartments;
d. peripherally sealing a second film about the perimeter of the compartmented support member to form a perimeter seal; and
e. positioning a rupturable seal between said at least two compartments, the seal being rupturable due to manual squeezing of at least one compartment so as to allow the food additive to mix with the food product;
wherein said rupturable seal has a lower rupture pressure compared to said perimeter seal, and wherein said food item can be marinated directly in said package.

10. The method of claim 9, further comprising a secondary seal about the perimeter of the package adjacent to at least one of the two compartments.

11. The method of claim 9, further comprising an opening means.

12. The method of claim 11, wherein the opening means is selected from the group consisting of: a tear notch disposed at an edge of the package, a pull tab disposed at a corner of the package, a tear strip that extends laterally across the package, a plastic reclosable fastener that extends laterally across the package, and combinations thereof.

13. The method of claim 9, wherein the food additive is selected from the group comprising: marinade, proteolytic enzyme, bactericide, fungicide, preservative, wetting agent, antioxidant, viscosity control agent, brine, curing agent, flavoring agent, or combinations thereof.

14. The method of claim 9, wherein the food product is at least one meat, vegetable, or combinations thereof.

15. The method of claim 9, wherein said rupturable seal comprises one or more stress risers.

16. The method of claim 9, wherein the distance between said rupturable seal and an end of said package is about ¼ to ⅓ the length of the package.

17. A method of marinating a food product in a package, the process comprising:
a. forming a first thermoformable thermoplastic film into a compartmented support member having at least two compartments wherein a first compartment is adapted to contain a food additive and a second compartment is adapted to contain a food product;
b. loading the compartmented support member with a charge of frozen food additive into a first compartment and a charge of a food product into a second compartment;
c. applying vacuum to the first and second charged compartments;
d. peripherally sealing a second film about the perimeter of the compartmented support member; and
e. positioning a rupturable seal between said at least two compartments, the seal being rupturable due to manual squeezing of at least one compartment so as to allow the food additive to mix with the food product;
wherein said rupturable seal has a lower rupture pressure compared to said perimeter seal, and wherein said food item can be marinated directly in said package.

18. The method of claim 17, further comprising a secondary seal about the perimeter of the package adjacent to at least one of the two compartments.

19. The method of claim 17, further comprising an opening means.

20. The method of claim 19, wherein the opening means is selected from the group consisting of: a tear notch disposed at an edge of the package, a pull tab disposed at a corner of the package, a tear strip that extends laterally across the package, a plastic reclosable fastener that extends laterally across the package, and combinations thereof.

21. The method of claim 17, wherein the food additive is selected from the group comprising: marinade, proteolytic enzyme, bactericide, fungicide, preservative, wetting agent, antioxidant, viscosity control agent, brine, curing agent, flavoring agent, or combinations thereof.

22. The method of claim 17, wherein the food product is at least one meat, vegetable, or combinations thereof.

23. The method of claim 17, wherein said rupturable seal comprises one or more stress risers.

24. The method of claim 17, wherein the distance between said rupturable seal and an end of said package is about ¼ to ⅓ the length of the package.
